(19) United States
(12) Patent Application Publication
(10) Pub. No.: US 2026/0289254 A1
(43) Pub. Date: Sep. 24, 2026

(54) SYSTEM

(71) Applicant: SoftBank Group Corp., Tokyo (JP)

(72) Inventor: Masaki FUKE, Tokyo (JP)

(73) Assignee: SoftBank Group Corp., Tokyo (JP)

(21) Appl. No.: 19/560,196

(22) Filed: Mar. 9, 2026

(30) Foreign Application Priority Data
Mar. 19, 2025 (JP) 2025-044561

(51) Int. Cl. G06N 3/0475; G06F 18/2431; G06N 3/045

(52) U.S. Cl. CPC G06N 3/0475; G06F 18/2431; G06N 3/045

(57) ABSTRACT

A system includes a processor that is configured to parse, by using a natural language processing technique, data received from a user terminal that inputs information, to perform syntactic analysis of the data and to determine whether the data includes sensitive content, score a degree of sensitivity of the data based on an evaluation criterion, using a result of the syntactic analysis of the data, and input a prompt to a generative AI model, the prompt instructing the generative AI model to generate a suggestion sentence based on a result of the scoring.

### CROSS-REFERENCE TO RELATED APPLICATION

This application is based on and claims priority under 35 USC 119 from Japanese Patent Application No. 2025-044561 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional communication systems allow users to freely input and transmit natural language messages without sufficiently supporting the users in recognizing and controlling the degree of sensitive or potentially harmful content contained in such messages. As a result, messages including harsh, offensive, or otherwise sensitive expressions may be transmitted without adequate awareness by the sender, which can unintentionally cause psychological harm, discomfort, or conflict for the receiver. Furthermore, even when certain content is recognized as sensitive, known systems do not adequately provide an automated and systematic mechanism to (i) quantify or score the degree of sensitivity based on a consistent evaluation criterion, (ii) utilize such scoring to generate appropriate suggestion sentences that guide users toward more considerate wording, and (iii) control the display of sensitive content on the receiving side, including hiding the content or presenting it in softened form. In addition, existing systems do not sufficiently leverage generative AI models through explicit prompt control to automatically generate suggestion sentences and summary sentences that soften expressions while preserving the essential meaning of the original information. Therefore, there is a need for a system that can automatically analyze user-input data using natural language processing, determine and score the sensitivity of the content, provide suggestion sentences through a generative AI model, manage identifiers and display control for transmitted information so that sensitive parts can be hidden on the receiving side, and generate summarized versions of the information in softened expressions.

### SUMMARY

To solve the above-described problems, an embodiment of the present invention provides a system comprising a processor, wherein the processor is configured to parse, by using a natural language processing technique, data received from a user terminal that inputs information, to perform syntactic analysis of the data and to determine whether the data includes sensitive content. Based on a result of the syntactic analysis, the processor is further configured to score a degree of sensitivity of the data according to a predetermined evaluation criterion. The processor is configured to input a prompt to a generative AI model, the prompt instructing the generative AI model to generate a suggestion sentence based on a result of the scoring, thereby enabling the system to present to the user an alternative expression or guidance that can reduce the sensitivity of the message. In certain embodiments, the processor is further configured to assign an identifier to information that has been transmitted and to apply a setting at a receiving side so that sensitive content included in the information is hidden, thereby allowing the receiver to be protected from immediate exposure to potentially harmful content and to selectively view such content. In additional embodiments, the processor is configured to input a prompt to a generative AI model, the prompt instructing the generative AI model to generate a summary sentence for summarizing the information in softened expressions, so that the receiver can understand the essential meaning of the information with reduced emotional impact. Through the combination of natural language processing-based sensitivity determination and scoring, prompt-controlled generative AI for suggestion and summary generation, and identifier-based display control on the receiving side, the system effectively supports safer and more considerate digital communication.

The term “system” refers to an arrangement including at least one processor and, optionally, one or more memories, communication interfaces, and other hardware and software components configured to execute the processing described in the claims.

The term “processor” refers to a hardware processing unit, such as a central processing unit (CPU), graphics processing unit (GPU), application-specific integrated circuit (ASIC), field-programmable gate array (FPGA), or any combination thereof, that executes instructions to perform the functions recited in the claims.

The term “user terminal” refers to an electronic device operated by a user, such as a smartphone, tablet, personal computer, or other communication device, that inputs information and transmits data to the system.

The term “data” refers to information, including natural language text or text-equivalent representations, that is input by a user through a user terminal and processed by the processor.

The term “natural language processing technique” refers to any computational method or algorithm that analyzes and processes human language text, including but not limited to tokenization, part-of-speech tagging, parsing, semantic analysis, and machine learning-based language understanding.

The term “syntactic analysis” refers to a process of analyzing the grammatical structure of text, including identifying words, phrases, and their relationships, in order to determine the structural composition of a sentence.

The term “sensitive content” refers to content that is determined, based on one or more rules, models, or criteria, to include expressions that may be harsh, offensive, discriminatory, aggressive, or otherwise likely to cause psychological discomfort, harm, or conflict for a receiver.

The term “degree of sensitivity” refers to a quantitative or qualitative level indicating how sensitive the content is, based on factors such as intensity of negative expressions, presence of insults, or other predetermined indicators.

The term “evaluation criterion” refers to one or more rules, thresholds, scoring models, or algorithms used to assess and quantify the degree of sensitivity of the data.

The term “scoring” refers to assigning a numerical value, category, or other measurable index to the degree of sensitivity of the data according to the evaluation criterion.

The term “generative AI model” refers to a machine learning model or artificial intelligence model that is capable of generating natural language text based on input prompts, including but not limited to large language models and other text generation models.

The term “prompt” refers to an input instruction, including one or more phrases, sentences, or structured tokens, provided to the generative AI model to control or guide the generation of output text.

The term “suggestion sentence” refers to a sentence or set of sentences generated by the generative AI model, based on the prompt and the scoring result, which proposes alternative expressions, wording, or guidance intended to reduce or mitigate sensitive content.

The term “identifier” refers to a unique or distinguishable value, such as an ID, code, or tag, associated with transmitted information, which allows the system to manage, reference, and control display of that information.

The term “setting at a receiving side” refers to display control information, flags, or configuration parameters applied by the system so that, on a receiver's device or interface, sensitive content can be selectively hidden, masked, or controlled in its presentation.

The term “hidden” refers to a display state in which sensitive content is not directly shown to the receiver, and may instead be replaced by a placeholder, warning message, or selectively revealed content.

The term “summary sentence” refers to text generated by the generative AI model that concisely represents the essential meaning of the original information while omitting details and, in particular, softening or reducing sensitive expressions.

The term “softened expressions” refers to wording that conveys the essential meaning or intent of the original content while reducing harshness, directness, offensiveness, or emotional impact through more moderate or considerate language.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

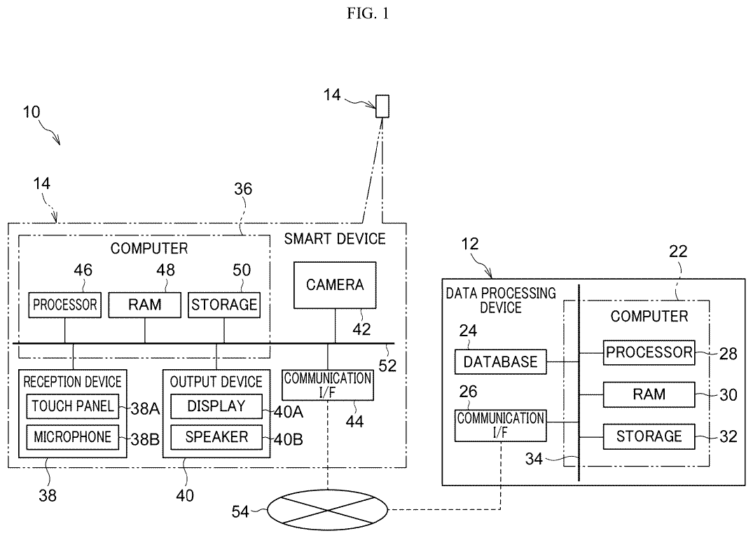

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

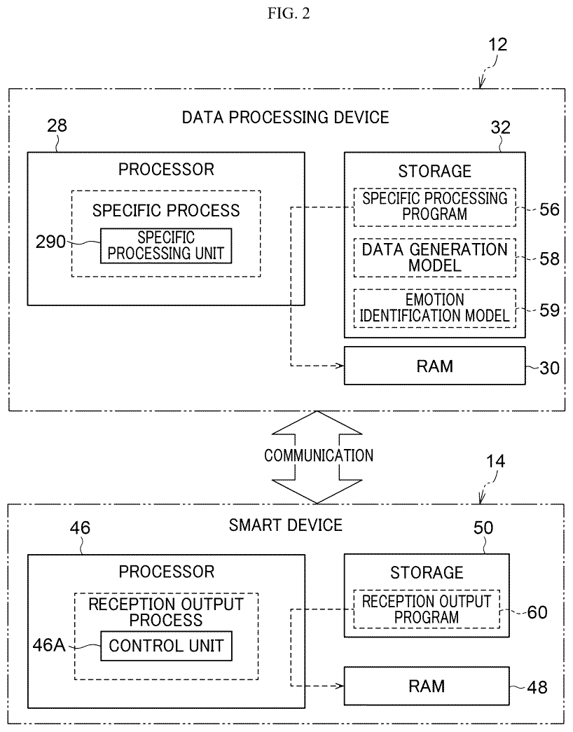

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### EXAMPLE 1

Description follows regarding a flow of the specific processing in an Example 1. The units of the system described below are implemented by the data processing device 12 and the smart device 14. The data processing device 12 is called a “server” and the smart device 14 is called a “terminal”.

In modern networked communication environments, users frequently exchange natural language messages via terminals such as smartphones and personal computers. Conventional content filtering technologies, including simple keyword filters and static rule-based classifiers, are limited in their ability to accurately detect nuanced, context-dependent sensitive content, such as insults, harassment, or psychologically harmful expressions. These conventional techniques often generate false positives that unnecessarily block benign messages, and false negatives that allow harmful messages to be delivered. Furthermore, conventional systems typically provide only binary allow/deny decisions or generic warnings, without offering concrete, context-aware alternative expressions that assist users in reformulating their messages into softer, less harmful language.

In addition, existing systems generally treat natural language processing and user interface feedback as separate, non-integrated components. They do not utilize iterative, model-in-the-loop workflows in which a sensitivity classifier and a generative language model are cooperatively controlled by a server to support multi-step refinement of user-authored text. As a result, the processing pipeline is not optimized for interactive sensitivity reduction: the server neither dynamically adjusts prompts supplied to a generative model based on sensitivity scores and reasons, nor ensures that generated alternatives are themselves re-evaluated and refined toward a target sensitivity level.

Moreover, current systems that attempt to hide sensitive content on the receiver side often merely suppress or mask the entire message, leading to a loss of communicative value. They generally do not maintain structured associations between original messages, sensitivity scores, control metadata, and multiple alternative outputs such as softened summaries or reformulated proposals generated by an artificial intelligence model. Consequently, recipients may either be fully exposed to harmful content or deprived of the underlying intent that could have been conveyed in a safer form.

There is therefore a need for a computer-implemented technical solution that improves the way servers process natural language messages by: (i) performing integrated syntactic and semantic analysis to compute quantitative sensitivity scores; (ii) generating, based on those scores and associated sensitivity reasons, structured prompt sentences for generative language models; (iii) controlling the generative models to produce alternative expressions and soft summaries that preserve user intent while reducing harm; (iv) iteratively re-evaluating and refining user messages until they satisfy a predetermined sensitivity condition; and (v) managing identifiers and display control information so that receiving terminals can hide or partially display sensitive content while presenting automatically generated, soft alternatives. Such a solution improves the functioning of the computer system itself by providing a more accurate, context-aware, and iterative message-processing pipeline that cannot be achieved by conventional rule-based or single-pass filtering mechanisms.

The specific processing by the specific processing unit 290 of the data processing device 12 in Example 1 is realized by the following means.

The present invention provides a server comprising a processor configured to acquire character information transmitted from a user terminal, to perform syntactic analysis and semantic analysis on the character information using a natural language processing technique, to determine presence or absence of sensitive content included in the character information, and to calculate a quantitative sensitivity score representing a degree of sensitivity according to a sensitivity evaluation criterion, the processor further configured to, when the sensitivity score exceeds a predetermined threshold, generate a structured prompt sentence for instructing a generative artificial intelligence model to generate a correction proposal by embedding into an instruction sentence at least content of the character information, the sensitivity score, and a sensitivity reason, to input the prompt sentence to the generative artificial intelligence model, to acquire from the generative artificial intelligence model a proposal sentence including an alternative expression that maintains an intention of the character information while being less likely to hurt a recipient, to generate evaluation result notification information that includes the sensitivity score and the proposal sentence and to transmit the evaluation result notification information to the user terminal so as to cause the user terminal to display the proposal sentence, and to acquire from the user terminal corrected character information edited by a user based on the proposal sentence and to iteratively repeat, for the corrected character information, the calculation of the sensitivity score and the generation and input of the prompt sentence until the corrected character information satisfies a predetermined sensitivity condition, and the processor further configured to assign identification information to at least the character information and the proposal sentence, to store in association with the identification information the sensitivity score and display control information corresponding to a sensitivity level, and to transmit to a receiving terminal the display control information so that the receiving terminal hides or partially displays sensitive content while displaying, in place of the sensitive content, at least one of a summary sentence in a soft expression or the proposal sentence generated by the generative artificial intelligence model. This enables an improved computer-implemented message processing pipeline that accurately quantifies sensitivity, dynamically controls generative artificial intelligence models via context-rich prompt sentences, interactively guides users through multi-step refinement toward a target sensitivity level, and manages receiver-side display control with structured identifiers and soft alternatives, thereby enhancing the technical functioning of the server and terminals beyond conventional rule-based filtering and non-iterative content moderation systems.

The term “system” refers to an arrangement of one or more information processing devices, including at least a server and one or more terminals, that cooperate via a communication network to execute the claimed processing.

The term “server” refers to an information processing device, or a group of information processing devices, that includes at least one processor and a memory, and that executes programs to perform the analysis, scoring, prompt generation, generative model interaction, and notification processing described in the claims.

The term “processor” refers to a hardware execution unit, such as a central processing unit or a graphics processing unit, or a combination thereof, that executes instructions stored in a memory to perform the functions described in the claims.

The term “user terminal” refers to an electronic device operated by a user, such as a mobile device, a portable information processing device, or a stationary information processing device, that transmits character information to the server and displays information received from the server to the user.

The term “receiving terminal” refers to an electronic device that receives, from the server, at least one of character information, a proposal sentence, or a summary sentence, and that controls display of such information to a recipient according to display control information.

The term “character information” refers to text data including one or more characters, symbols, or punctuation marks representing a natural language message input by a user through a user terminal and transmitted to the server.

The term “natural language processing technique” refers to a computational technique or algorithm that processes natural language text, including at least one of tokenization, part-of-speech tagging, syntactic parsing, semantic analysis, or contextual embedding.

The term “syntactic analysis” refers to processing that determines a structural relationship among words or tokens in character information, such as a grammatical structure, by using a natural language processing technique.

The term “semantic analysis” refers to processing that interprets or infers meanings, roles, or relationships represented by character information, including contextual meaning of words or phrases, by using a natural language processing technique.

The term “sensitive content” refers to content in character information that is estimated to have a risk of causing psychological discomfort, offense, harassment, or other negative impact on a recipient, based on a sensitivity evaluation criterion.

The term “sensitivity evaluation criterion” refers to a rule set, model configuration, or parameter set used by the processor to evaluate a degree of sensitivity of character information, including at least thresholds, weights, or classification categories for different types of sensitive content.

The term “sensitivity score” refers to a numerical value or probability distribution calculated by the processor that quantitatively represents a degree of sensitivity of character information according to the sensitivity evaluation criterion.

The term “sensitivity level” refers to a discrete or categorized classification, such as low, medium, or high, that is derived from the sensitivity score and indicates a graded degree of sensitivity of character information.

The term “sensitivity reason” refers to explanatory information representing at least one factor, feature, or pattern in the character information that contributed to a determination that the character information is sensitive or to a calculated sensitivity score.

The term “predetermined threshold” refers to a stored numerical value or condition used by the processor to decide whether a calculated sensitivity score is high enough to trigger generation of a prompt sentence, generation of a proposal sentence, or other processing.

The term “predetermined sensitivity condition” refers to a stored criterion indicating an acceptable range or upper limit of sensitivity, used by the processor to determine whether iterative correction of character information can be terminated.

The term “generative artificial intelligence model” refers to a trained computational model, such as a neural network model, that is configured to generate natural language text based on an input prompt sentence and that can output at least one of a proposal sentence or a summary sentence.

The term “prompt sentence” refers to text data that includes an instruction sentence and at least part of the character information, a sensitivity score, or a sensitivity reason, and that is supplied to a generative artificial intelligence model to control or condition natural language generation.

The term “instruction sentence” refers to a portion of a prompt sentence that explicitly describes, in natural language or a structured format, a task to be executed by the generative artificial intelligence model, such as generating a correction proposal or a soft summary.

The term “proposal sentence” refers to natural language text generated by the generative artificial intelligence model in response to a prompt sentence, the proposal sentence including an alternative expression that maintains an intention of the original character information while reducing a likelihood of hurting a recipient.

The term “alternative expression” refers to a reformulated textual expression that conveys substantially the same intent or core meaning as original character information but is modified to be less sensitive or less likely to cause discomfort.

The term “summary sentence” refers to natural language text generated by the generative artificial intelligence model that summarizes main semantic content of character information, and that is expressed in a softer or less offensive manner than the original character information.

The term “soft expression” refers to a language style that reduces directness, harshness, or confrontational tone of character information, thereby lowering a likelihood that a recipient feels attacked, insulted, or uncomfortable.

The term “evaluation result notification information” refers to data generated by the processor that includes at least the sensitivity score and a proposal sentence or summary sentence, and that is transmitted from the server to a user terminal or a receiving terminal for display.

The term “identification information” refers to a value, such as an identifier, key, or code, that uniquely or distinctively associates with at least one item of character information, a proposal sentence, or a summary sentence, and is used by the server to manage related records or display control information.

The term “display control information” refers to data indicating how content associated with a particular sensitivity level is to be presented on a receiving terminal, including whether sensitive content is to be hidden, partially displayed, or replaced with a proposal sentence or summary sentence.

The term “hide” refers to a display control operation in which sensitive content is not visually presented to a recipient on a display region of a receiving terminal, although related metadata or alternative content may be presented.

The term “partially display” refers to a display control operation in which only a portion or modified version of sensitive content is presented on a receiving terminal, such as masking, truncation, or replacement of selected portions.

The term “user” refers to a human operator who inputs character information through a user terminal, receives proposal sentences or summary sentences, and optionally edits character information based on the presented information.

The term “recipient” refers to a human person who is a target of communication for character information, proposal sentences, or summary sentences presented on a receiving terminal.

The term “iteratively repeat” refers to a processing mode in which the processor repeatedly executes sensitivity scoring, prompt sentence generation, and generative model interaction on successively corrected versions of character information until a predetermined sensitivity condition is satisfied.

The term “interactive refinement” refers to a process in which a user and the server cooperatively modify character information, such that the user edits character information based on proposal sentences or summary sentences, and the server re-evaluates and provides updated guidance.

The term “message processing pipeline” refers to a sequence of computer-implemented operations, including acquisition of character information, natural language analysis, sensitivity scoring, prompt generation, generative model inference, and notification, that are executed by the server to process user messages.

In the following embodiments, a server, one or more terminals, and a user cooperate to implement the claimed system. The server executes one or more programs stored in a memory by using a processor such as a central processing unit and, optionally, a graphics processing unit. The terminals execute client-side programs that interact with the server through a communication network.

A server uses general-purpose hardware such as a multicore central processing unit and a graphics processing unit mounted on an information processing apparatus. In one embodiment, the server uses a processor compatible with an x86-type instruction set, a system memory, a nonvolatile storage device, and a network interface. The server executes an operating system such as a UNIX-type operating system and an application framework such as a web application framework. The server loads, into the system memory, one or more software components including a natural language processing library, a numerical computation library, and a generative AI model inference library. As concrete but non-limiting examples, the server uses a transformer-type language model implementation, a tensor computation framework, and a tokenizer library.

A terminal uses hardware such as a mobile communication device, a tablet, or a personal computer including at least a display, an input device, a processor, and a memory. The terminal executes an operating system such as a mobile operating system or a desktop operating system and runs a client application implemented as a native application or a browser-based application. The terminal communicates with the server via a network such as a wireless communication network or a wired packet communication network, using protocols such as Hypertext Transfer Protocol over Transport Layer Security.

A user operates the terminal to input character information such as a text message. The terminal temporarily stores the character information in an input buffer in a random access memory and transmits the character information to the server as part of a structured data object. The character information is encoded as a sequence of characters in a character encoding such as Unicode.

The server stores a program in the memory to analyze the character information. The server uses a natural language processing technique to perform syntactic analysis and semantic analysis. In one embodiment, the server uses a tokenizer to convert the character information into a sequence of subword units and then uses a transformer-type neural network model to generate contextual vector representations for each token. The server uses a model that includes multiple self-attention layers, feedforward layers, and normalization layers. Each self-attention layer computes attention scores based on query, key, and value vectors derived from the token embeddings, and produces context-sensitive token embeddings. The server uses these embeddings as features for a classification head.

The server attaches a classification head to the final layer of the transformer encoder. The classification head includes at least one fully connected layer and an output layer that maps the encoder output to a fixed-length vector of real numbers representing logits for different sensitivity classes. During operation, the server inputs the tokenized and encoded character information to the model and obtains logits. The server converts the logits into probabilities by applying a softmax function. The server computes a sensitivity score, for example as a probability of a target class corresponding to sensitive content or as a weighted combination of probabilities across multiple sensitivity categories.

The server stores, in the memory, a sensitivity evaluation criterion including at least a mapping between numerical sensitivity scores and discrete sensitivity levels such as low, medium, and high, and at least one threshold value for determining whether to trigger generation of alternative text. The server compares the calculated sensitivity score with the stored threshold. When the sensitivity score exceeds the threshold, the server determines that the character information is sensitive and triggers prompt sentence generation and generative AI model inference.

The server generates a prompt sentence for a generative AI model. The server constructs the prompt sentence in a text buffer as a concatenation of an instruction sentence, the original character information, and optionally additional explanatory information such as the sensitivity score and a sensitivity reason. The instruction sentence specifies, in natural language, a generation task for the model. For example, the server generates a prompt sentence such as:

“You are an assistant that rewrites messages so that they do not hurt the other person. Preserve the main intent, but avoid insults.

Original message: “Your opinion is totally useless.”

Rewritten message:”

In another example, the server generates a prompt sentence such as:

“Classify the sensitivity level (low, medium, high) of the following message, explain the reason briefly, and then rewrite it so that it expresses disagreement politely without insulting the other person.

Message: “Your opinion is totally useless.””

In yet another example, the server generates a prompt sentence such as:

“Summarize the following message in neutral and gentle language so the recipient will not feel offended, while preserving the core intent:

“Your opinion is totally useless.””

The server uses these prompt sentences as input to a generative AI model. In one embodiment, the generative AI model is a transformer-based decoder or encoder-decoder model configured for text generation. The model consists of multiple layers of self-attention and cross-attention (in the case of an encoder-decoder architecture), with parameters such as weight matrices for attention projections, feedforward networks, and layer normalization parameters. The model parameters are stored in the server's nonvolatile storage and loaded into memory at runtime.

The server performs generative inference by encoding the prompt sentence into tokens using a tokenizer and feeding the resulting token sequence into the generative model. The processor uses a tensor computation library to perform matrix multiplications and non-linear transformations required by the attention mechanism and feedforward networks. The server controls generation hyperparameters such as sampling temperature, top-k or top-p sampling thresholds, and maximum output length. The model iteratively predicts the next token conditioned on the input prompt sentence and the tokens generated so far, and the server concatenates these tokens to form a proposal sentence.

The server post-processes the proposal sentence by removing leading or trailing whitespace, removing unnecessary labels that the model may have generated, and ensuring conformance with length constraints. The server may optionally pass the proposal sentence back into the sensitivity classifier to confirm that the sensitivity score is below a specified target level. If the generated proposal remains too sensitive, the server modifies the instruction sentence to impose stricter constraints, such as requiring very polite and non-confrontational language, and re-generates a prompt sentence and a corresponding proposal sentence.

The server constructs evaluation result notification information as a structured data object containing at least the sensitivity score and the proposal sentence. The server transmits this information to the terminal. The terminal parses the received data and displays, on a graphical user interface, the proposal sentence to the user together with an indication that the original character information is sensitive. The terminal may display the original character information and the proposal sentence side by side and provide controls that allow the user to adopt, edit, or reject the proposed alternative expression.

The user reviews the proposal sentence on the terminal. The user may directly adopt the proposal sentence as the corrected character information or may edit the proposal sentence to reflect the user's intent more accurately. The terminal transmits the corrected character information to the server. The server repeats the sensitivity evaluation, prompt generation, and generative model inference for the corrected character information until the sensitivity score satisfies a predetermined sensitivity condition stored in memory. Through this iterative refinement, the system supports multi-step correction at a granularity and speed that human-only review cannot easily achieve.

The server assigns identification information to each piece of character information and each proposal sentence. The server stores the identification information together with the associated sensitivity score and display control information in a data structure of a data storage system, such as a relational table or a key-value store. The server uses the identification information to manage mappings between original messages, alternative expressions, and display policies.

When the character information is to be delivered to a recipient, the server uses the stored display control information to determine how the content should be rendered at a receiving terminal. For messages with high sensitivity scores, the server may transmit to the receiving terminal only a summary sentence or proposal sentence generated by the generative AI model, while replacing or masking the original character information. The summary sentence may be generated using a prompt sentence that instructs the generative model to create a gentle summary, for example:

“Summarize the following message in neutral and gentle language so that the recipient will not feel offended, while preserving the main intent.

Message: “Your opinion is totally useless.””

The server thereby enables the receiving terminal to present the underlying intent of the message in a softened form, reducing psychological harm while preserving communication value.

From a technical perspective, the server improves computer functionality in several ways. The server uses a quantitative sensitivity score and an explicit sensitivity evaluation criterion to drive prompt sentence construction and generative model behavior. Instead of merely automating human review, the server executes an algorithm that dynamically adjusts prompts and performs iterative refinement based on feedback from both the classifier and the generative model. By storing and reusing tokenized representations and by batching model inferences, the server reduces redundant computation and improves processing throughput for large volumes of messages. The use of attention-based neural architectures, with learned embeddings and multi-layer self-attention, allows the server to capture long-range dependencies and subtle contextual cues of sensitivity more accurately than simple keyword or rule-based systems, thereby lowering false positives and false negatives.

The server trains the classifier and generative model parameters in advance using large datasets of annotated messages. During training, the server defines an error function such as cross-entropy loss between predicted sensitivity labels and ground truth labels for the classifier, and a negative log-likelihood loss for predicted tokens in the generative model. The server uses an optimization algorithm such as stochastic gradient descent with adaptive learning rate methods to update the model weights. The server may perform data augmentation techniques such as paraphrase generation, back-translation, or noise injection to increase robustness. As a result, at inference time, the server can process messages quickly and with high accuracy, providing technical improvements in classification precision and generation appropriateness.

The server manages data structures specifically tailored to this processing, including: (i) token arrays representing character information; (ii) embedding matrices storing intermediate feature representations; (iii) mapping tables associating message identifiers with sensitivity scores and display control flags; and (iv) prompt buffers that store dynamically constructed prompt sentences. By structuring data in these forms, the server enables efficient memory access patterns and minimizes communication overhead between modules handling classification, prompt generation, and generative inference. This improves computational efficiency and reduces latency, which is critical for interactive applications.

The server uses non-conventional control logic in which a sensitivity classifier and a generative model are orchestrated in a closed-loop process. The server does not merely apply a fixed rule set; instead, the server uses the sensitivity score and sensitivity reason as features to derive prompt sentences that directly condition the behavior of the generative model. This feedback loop results in automatic selection of an appropriate generation task (e.g., mild rewrite versus strong softening versus summarization) and specification of constraints (e.g., politeness level) that are not provided by traditional content filters. Consequently, the system achieves technical effects of higher precision in sensitive content handling and lower computational cost per successful correction, because the iterative process converges in a small number of model calls.

Alternative embodiments are also possible. In one embodiment, the server uses an encoder-only transformer model for classification and a separate decoder-only transformer model for generation. In another embodiment, the server uses a single encoder-decoder model that performs both classification and generation by treating the sensitivity label as a special token in the output. In yet another embodiment, the server adjusts model parameters such as layer counts, hidden dimension sizes, or vocabulary size depending on available hardware resources to balance speed and accuracy.

In some embodiments, the terminal performs part of the natural language processing. For example, the terminal may perform preliminary tokenization or language detection and send preprocessed tokens to the server, thereby reducing server-side computation and network payload size. In other embodiments, the server offloads some computation to a dedicated accelerator module or a separate inference server. These variations still conform to the claimed invention, because the processor of the server remains configured to calculate sensitivity scores, generate prompt sentences, and control generative model behavior based on those scores.

Through these configurations, the server, terminal, and user cooperate to implement a concrete, hardware-executed message processing pipeline. The system goes beyond mere automation of human review by integrating advanced neural network architectures, structured prompt sentence generation, and iterative classifier-generator feedback in a manner that improves processing speed, accuracy, and resource utilization within the computer system itself.

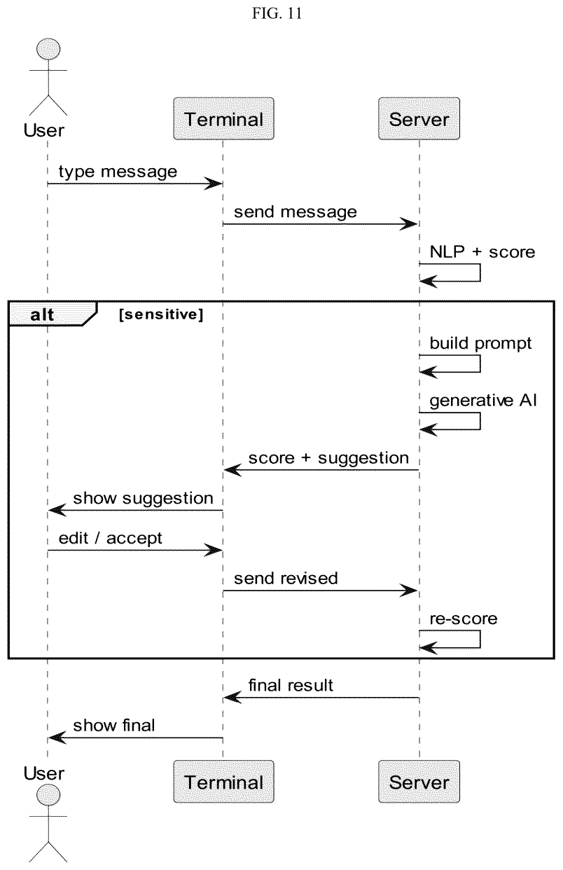

The following describes the processing flow using FIG. 11.

### Step 1:

User operates the terminal to input character information.

User enters a natural language message, for example, “Your opinion is totally useless.” into an input field displayed on the terminal. The input of this step is a sequence of characters typed by the user, and the output is character information temporarily stored in an input buffer in the terminal memory. Terminal converts key events into a text string according to a character encoding such as Unicode and stores the resulting text string in a variable managed by the client application.

### Step 2:

Terminal transmits the character information to the server.

Terminal detects that the user has activated a control such as a “Check” or “Send” button. The input of this step is the character information stored in the input buffer, and the output is a structured request transmitted over a network. Terminal packages the character information into a data structure, such as a JSON object with a field “message”, and performs data encoding into a byte stream. Terminal then uses a network stack implementing a protocol such as HTTPS to send an HTTP request containing the encoded character information to a server endpoint.

### Step 3:

Server receives and parses the character information.

Server accepts the incoming network packet at a communication interface and reconstructs the HTTP request. The input of this step is the encoded request from the terminal, and the output is a decoded text string representing the message. Server uses an HTTP library to parse the header and body of the request, extracts the “message” field from the structured data, and stores the extracted character information in a server-side variable for further processing.

### Step 4:

Server normalizes and cleans the character information.

Server receives the raw text string as input and outputs a normalized text string. Server applies text normalization operations such as Unicode normalization, conversion to lower case, and removal of control characters. Server executes these operations using a string-processing library, thereby transforming the input sequence of code points into a canonical form that reduces variance due to different encodings or typographic styles.

### Step 5:

Server tokenizes the normalized character information.

Server uses the normalized text as input and produces tokenized data as output. Server invokes a tokenizer associated with the generative AI model to segment the text into subword tokens and to map each token to a numerical token identifier. Server generates arrays of token identifiers and attention masks. This processing step converts human-readable text into numerical features suitable for input to neural network models.

### Step 6:

Server performs feature extraction and sensitivity classification.

Server takes the token identifiers and attention masks as input and outputs a sensitivity score and a sensitivity level. Server feeds the tokenized data into a trained transformer-based classifier implemented as a neural network. The classifier computes contextual embeddings via self-attention layers and then passes the embeddings to a classification head. Server applies a softmax function to the logits generated by the classification head to compute a probability distribution over sensitivity classes. Server maps the probability for sensitive classes to a scalar sensitivity score and determines a sensitivity level such as low, medium, or high according to stored threshold values.

### Step 7:

Server determines the need for generative processing based on the sensitivity score.

Server uses the sensitivity score and sensitivity level as input and produces a decision flag indicating whether to generate an alternative expression. Server compares the sensitivity score with a predetermined threshold stored in memory. If the score exceeds the threshold, server sets a flag “sensitive =true”; otherwise, server sets “sensitive =false”. The flag serves as control data for subsequent processing.

### Step 8:

Server generates a prompt sentence for a generative AI model.

Server uses, as input, the normalized character information, the sensitivity score, and optionally a sensitivity reason derived from classifier outputs such as attention weights or class probabilities. The output is a prompt sentence stored as a text buffer. Server constructs an instruction sentence that defines the generation task, concatenates the instruction sentence with the original message and contextual information, and forms a single text string. For example, server generates a prompt sentence:

“You are an assistant that rewrites messages so that they do not hurt the other person. Preserve the main intent, but avoid insults.

Original message: “Your opinion is totally useless.”

Rewritten message:”

Server writes this concatenated text into a buffer for use as input to the generative AI model.

### Step 9:

Server executes generative inference using the generative AI model.

Server accepts the prompt sentence as input and outputs a proposal sentence. Server tokenizes the prompt sentence using a tokenizer compatible with the generative AI model, then feeds the token IDs into a transformer-based decoder model. The model computes successive token predictions using multi-head self-attention and feedforward networks, with sampling parameters such as temperature and top-p controlling randomness. Server iteratively decodes tokens until an end-of-sequence condition is met, then converts the sequence of token IDs back into text to obtain a proposal sentence, for example: “Your perspective is interesting, but perhaps we could look at some other options as well.”

### Step 10:

Server post-processes and optionally re-evaluates the proposal sentence.

Server uses the raw proposal sentence from the generative model as input and produces a cleaned and validated proposal sentence as output. Server removes redundant prefixes such as “Rewritten message:” and trims whitespace. Server may pass the cleaned proposal sentence back into the sensitivity classifier used in Step 6 to compute a new sensitivity score. If the new sensitivity score still exceeds a stricter target threshold, server modifies the instruction part of the prompt sentence (for example, by adding a requirement for “very polite, non-confrontational language”) and repeats Steps 8 and 9 until the proposal satisfies the sensitivity condition.

### Step 11:

Server prepares evaluation result notification information.

Server uses, as input, the original character information, the sensitivity score, the sensitivity level, and the final proposal sentence, and outputs a structured notification object. Server assembles a data structure that includes fields such as “original_message”, “sensitivity_score”, “sensitivity_level”, and “proposal_sentence”. Server may also include explanatory text for the user. Server converts this structured data into a transmittable format such as a serialized JSON string.

### Step 12:

Server transmits the evaluation result notification information to the terminal.

Server takes the serialized notification as input and outputs a network response. Server embeds the serialized data as the body of an HTTP response, attaches appropriate headers, and uses the network interface to send the response to the terminal. The transfer uses a secure protocol such as HTTPS, and the server may compress the payload to reduce bandwidth usage.

### Step 13:

Terminal receives and renders the evaluation results.

Terminal uses the HTTP response as input and outputs a graphical display for the user. Terminal decodes the response body, parses the structured data, and extracts the sensitivity score, sensitivity level, and proposal sentence. Terminal then updates the user interface, for example by displaying a warning that the message is sensitive and showing the proposal sentence in a separate text area. Terminal may highlight differences between the original message and the proposal to assist user understanding.

### Step 14:

User reviews and edits the proposal sentence.

User uses the displayed content as input and produces corrected character information as output. User may accept the proposal sentence without change, or may edit the text within an editable input field on the terminal. User may adjust wording to better reflect the intended meaning while maintaining a polite tone. Terminal records the edited text as a new version of the character information in its input buffer.

### Step 15:

Terminal transmits the corrected character information to the server for re-evaluation.

Terminal uses the edited text as input and outputs another structured request to the server. Terminal constructs a new request containing the corrected character information and sends it through the network. This step is similar to Step 2, but the content is the revised message created after the user's review.

### Step 16:

Server re-evaluates the corrected character information and determines completion.

Server uses the corrected character information as input and outputs a decision on whether refinement is complete. Server repeats Steps 3 through 7 for the corrected message, computing a new sensitivity score and sensitivity level. If the score now satisfies the predetermined sensitivity condition, server marks the message as acceptable and sets a completion flag. If not, server may again generate a new prompt sentence and proposal sentence by repeating Steps 8 to 10, thereby continuing the iterative refinement loop.

### Step 17:

Server assigns identification information and stores control metadata.

Server uses the finalized character information and associated proposal or summary sentences as input and outputs stored records in a data repository. Server generates a unique identifier for each message and associates the identifier with values such as sensitivity score, sensitivity level, and display control information. Server writes these associations to a storage system such as a database table. This data structure enables later retrieval and consistent enforcement of display policies at receiving terminals.

### Step 18:

Server generates and transmits receiver-side content including soft summaries when required.

Server uses stored messages, sensitivity metadata, and identification information as input and outputs receiver-specific content. When a message is destined for a receiving terminal and has a high sensitivity level, server constructs a prompt sentence instructing the generative AI model to generate a soft summary, for example:

“Summarize the following message in neutral and gentle language so that the recipient will not feel offended, while preserving the main intent.

Message: “Your opinion is totally useless.””

Server performs generative inference to obtain a summary sentence and then, based on the display control information, sends to the receiving terminal either the summary alone or the summary together with a masked version of the original message.

### Step 19:

Receiving terminal displays content to the recipient according to display control information.

Terminal at the recipient side uses the server's response and display control information as input and outputs a rendered view for the recipient. Terminal parses the received data, determines according to flags whether to hide or partially display the original message, and presents the soft summary or proposal sentence in the main display area. Terminal may provide an interface for revealing the original content subject to policy rules. In this way, the processing of the server and terminals jointly converts input character information into controlled and softened output that is computed through classification, prompt sentence generation, and generative AI model inference.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In network-based communication environments such as enterprise messaging platforms, collaboration tools, and electronic mail systems, users increasingly exchange free-form natural language messages in real time. Conventional content filtering technologies typically rely on static keyword lists, simple rule-based checks, or coarse-grained classification models to detect offensive or inappropriate content. Such approaches suffer from several technical limitations: they cannot robustly capture context-dependent nuances of natural language, they frequently produce false positives and false negatives, and they provide little or no assistance for generating alternative, less sensitive wording. As a result, existing systems either block or flag messages in a binary manner without assisting the user in reformulating the message, thereby degrading user experience and reducing communication efficiency.

Moreover, when machine learning models are employed at all, they are often used only as passive classifiers. These models are not tightly integrated with generative models or real-time user interfaces, and they do not generate structured, machine-actionable data that downstream systems can utilize to control display, selectively hide sensitive portions, or dynamically guide user interaction. This lack of integration leads to increased latency, redundant computation, and inconsistent handling of sensitive content across different devices and services.

In addition, existing systems fail to provide a unified processing pipeline in which (i) incoming text is normalized and converted into numerical representations, (ii) a trained classification model computes a quantitative sensitivity evaluation, (iii) a prompt sentence is automatically constructed based on the evaluation and extracted sensitive segments, and (iv) a generative model outputs alternative or summary expressions that are immediately consumable by a user interface. Without such a pipeline, it is difficult to achieve real-time, context-aware rewriting assistance that both reduces the risk of harm and preserves the user's communicative intent.

Furthermore, conventional systems do not consistently attach identification information and control information to messages so that receiving devices can automatically hide, emphasize, or otherwise control presentation of sensitive portions. This lack of structured control data limits the ability of client devices to adaptively display content according to user preferences, organizational policies, or regulatory requirements. Consequently, there is a need for a computer-implemented technique that improves the technical process of analyzing, transforming, and delivering user-generated text, by combining discriminative and generative models with structured metadata and interactive feedback, thereby improving accuracy, responsiveness, and safety in communication systems.

The specific processing by the specific processing unit 290 of the data processing device 12 in Application Example 1 is realized by the following means.

The present invention provides a server comprising a processor configured to receive, via a communication interface, character information from a user terminal, to preprocess the character information by applying a language processing operation including tokenization and conversion into numerical representations, to execute inference using a trained classification model on the numerical representations so as to calculate an evaluation value indicating presence or absence of sensitive content and a degree of sensitivity, to determine, based on the evaluation value, whether the character information is sensitive and to extract, when the character information is determined to be sensitive, at least one sensitive portion from within the character information, to automatically construct a prompt sentence based on a determination result and the extracted sensitive portion for causing a generative artificial intelligence model to generate an alternative or softened expression, to input the prompt sentence to the generative artificial intelligence model and obtain response information including at least one alternative or summary expression, to generate structured data including the evaluation value, the at least one alternative or summary expression, and control information for display, and to transmit the structured data to the user terminal so that the user terminal can control display of sensitive content and present the at least one alternative or summary expression to a user in real time. This enables an improved computer-implemented communication process in which sensitivity analysis and generative rewriting are integrated into a single pipeline, reduces misclassification and user burden by providing context-aware alternative expressions, and supplies structured control data that allows client devices and downstream systems to programmatically manage the display and transmission of sensitive content with enhanced accuracy and efficiency.

The term “processor” refers to a hardware or virtual computing unit, such as a central processing unit or a processing core in a computing device, that is configured to execute instructions and perform arithmetic, logical, control, and input/output operations to carry out the functions described herein.

The term “user terminal” refers to an information processing device operated by a user, such as a personal computer, a mobile device, or another client device, that is capable of inputting character information, transmitting the character information to a server, and displaying information received from the server.

The term “character information” refers to text data representing a sequence of characters, symbols, or words, including natural language messages, that are input by a user and processed by the system.

The term “communication unit” refers to a hardware or software component that enables data transmission and reception between the server and the user terminal, including components that utilize wired or wireless communication protocols.

The term “language processing technique” refers to a computational technique for analyzing or transforming natural language text, including but not limited to tokenization, segmentation, normalization, and conversion of text into numerical representations suitable for input to a machine learning model.

The term “word sequence” refers to an ordered list of lexical units, such as tokens or words, obtained by segmenting the character information according to a language processing technique.

The term “numerical representation” refers to a formatted representation of text data as numerical values, such as token identifiers, embeddings, or feature vectors, which can be input to a machine learning model for inference.

The term “classification model” refers to a trained machine learning model, including but not limited to a neural network model, configured to receive numerical representations of text and output one or more classification results such as labels, probabilities, or scores indicating properties of the text.

The term “inference process” refers to a computational operation in which a trained model receives input data and produces output data, such as class scores or predicted labels, without changing the parameters of the model.

The term “evaluation value” refers to a quantitative measure generated by the classification model that indicates the presence or absence of sensitive content and a degree of sensitivity of the character information.

The term “sensitive content” refers to a portion of character information whose expression is determined to have a potential to cause discomfort, offense, or harm to another party, according to a predetermined evaluation criterion.

The term “degree of sensitivity” refers to a numeric or categorical value indicating a relative level of sensitivity of character information, including multiple levels such as low, medium, or high sensitivity.

The term “sensitive portion” refers to a segment, substring, or subset of character information that is identified as containing sensitive content or contributing significantly to the degree of sensitivity.

The term “prompt sentence” refers to textual instruction data that is constructed based on an evaluation result and at least one sensitive portion, and that is provided as input to a generative artificial intelligence model to cause the model to generate an output such as an alternative expression or a summary expression.

The term “generative artificial intelligence model” refers to a machine learning model, such as a generative language model, configured to receive prompt data and generate new text data, including alternative expressions or summary expressions, based on the prompt.

The term “alternative expression” refers to a rewritten form of character information that is intended to preserve at least part of an original meaning while reducing sensitivity, harshness, or potential for offense.

The term “softened expression” refers to an alternative expression that reduces negative, aggressive, or offensive aspects of the original character information by modifying wording, tone, or structure.

The term “summary expression” refers to a shortened form of character information that reduces the amount of information while maintaining a main point, and that may also mitigate negative or aggressive wording.

The term “response information” refers to data output from the generative artificial intelligence model in response to a prompt sentence, including at least one alternative expression, a softened expression, a summary expression, or related explanatory information.

The term “structured data” refers to data organized according to a predefined format or schema, such as a record or document including fields for evaluation values, sensitive portions, alternative expressions, and control information, which can be programmatically processed by the user terminal or other systems.

The term “control information” refers to metadata or flags included in structured data that specify how content should be displayed or handled by a receiving device, including instructions to hide, emphasize, or otherwise control presentation of sensitive portions.

The term “display control” refers to an operation performed by a user terminal or receiving device to determine how character information and related data are visually presented to a user, including operations such as highlighting, masking, or changing visibility of certain portions.

The term “identification information” refers to an identifier associated with character information, such as a message identifier or content identifier, that allows a receiving apparatus or the system to relate control information and processing results to specific character information.

The term “receiving apparatus” refers to a device or system that receives character information and associated control information, and that can control the display or handling of sensitive portions according to the control information.

The term “transmission target information” refers to character information that has been confirmed as acceptable according to a sensitivity evaluation and is thereby permitted to be transmitted to an intended recipient device or service.

The term “predetermined threshold” refers to a reference value or condition defined in advance and used to determine whether a degree of sensitivity, evaluation value, or other measure meets a criterion for performing a particular operation, such as approving, rejecting, or rewriting a message.

The term “predetermined range” refers to a predefined interval or set of values of an evaluation value or degree of sensitivity, within which specific processing, such as generation of a summary expression, is to be executed.

The term “real time” refers to a processing characteristic in which the system analyzes and responds to character information with a latency sufficiently low that a user can interactively modify the character information before final transmission in an ongoing communication session.

In one embodiment, a server executes a software program that cooperates with a user terminal to analyze sensitivity of user-generated text and to generate alternative or summary expressions using a generative AI model. The server includes at least one processor, a memory, and a communication interface. The processor executes a backend application implemented, for example, in a general-purpose programming language such as Python running on an operating system such as a UNIX-like server operating system. The server optionally uses an accelerator such as a graphics processing unit for neural network inference.

The server stores in the memory a natural language classification model and a generative AI model. The server may implement the classification model using a transformer-based neural network architecture. In one example, the server uses a pretrained encoder-type transformer model that receives tokenized text and outputs contextual embeddings, and a classification layer that maps the embeddings to scores corresponding to sensitivity levels. The server may construct this classification model using a software library for transformer-based models. The server stores, in the memory, weight parameters of multiple self-attention layers, feedforward layers, and a final dense layer for classification. The server also stores a tokenizer definition, including a vocabulary, tokenization rules, and mapping tables from text tokens to integer identifiers.

The server stores, in the memory, the generative AI model used as a generative language model. In one example, the server uses a decoder-type transformer architecture that generates text in an autoregressive manner. The generative AI model includes multiple transformer decoder layers, each with self-attention and feedforward sublayers. The server stores the parameters of word embedding matrices, positional encoding, layer normalization, and output projection layers. The server may load these parameters from persistent storage into memory at startup to avoid repeated loading overhead.

The server receives, via the communication interface, character information from the user terminal. The user terminal is, for example, a personal computer, a smartphone, or a tablet, executing a client application such as a web browser or a native messaging application. The user inputs a message in a text input field provided by the user terminal. The terminal transmits the input text and associated metadata to the server over a network, for instance using a secure transport protocol such as HTTPS.

The server preprocesses the received character information using a language processing technique. The server converts the text to a normalized format, for example by converting characters to a standard case, removing unsupported control characters, and standardizing whitespace. The server then applies the tokenizer to segment the text into tokens and to convert the tokens into numerical representations. The server represents each token as an integer identifier and constructs sequences of token identifiers and associated attention masks. The server stores these sequences in a structured data format, such as multi-dimensional arrays in the memory, which serve as input to the classification model.

The server applies the classification model to the numerical representations to compute an evaluation value indicating the degree of sensitivity. The classification model receives token sequences and attention masks and computes hidden representations by propagating the data through multiple self-attention layers and feedforward layers. The model aggregates contextual information over the entire sequence and outputs a fixed-length vector at a designated position, such as a special classification token. The server applies a final dense layer and a softmax or similar activation function to obtain probability values for several classes, such as “non-sensitive,” “moderately sensitive,” and “highly sensitive.” The server uses these probabilities as evaluation values and may compute a scalar sensitivity score by mapping the class probabilities to a numeric scale.

The server determines whether the character information is sensitive by comparing the evaluation value to a predetermined threshold. For example, the server determines that the message is sensitive when the probability of a sensitive class exceeds a configured sensitivity threshold. In some variants, the server also analyzes token-level outputs, attention distributions, or gradient-based saliency values to identify specific sections of the character information that contribute most to the sensitivity classification. The server extracts these sections as sensitive portions, represented as character spans or token index ranges.

The server constructs a prompt sentence for the generative AI model based on the determination result and the extracted sensitive portion. The server programmatically composes a text instruction in natural language that includes: an explanation that the original message is potentially sensitive; a request to rewrite the message in a more polite or constructive manner; and the original message or a focused excerpt highlighting the sensitive portion. The server may include formatting directives in the prompt sentence to specify the desired output structure, such as requiring a sensitivity comment and one or more alternative expressions. The server uses a predefined template and inserts the dynamic content, including the original message and sensitivity level, into the template.

The server inputs the prompt sentence to the generative AI model. When the generative AI model is deployed as a local model, the server tokenizes the prompt, converts it into token identifiers, and feeds the sequence into the decoder-type transformer model. The model then performs autoregressive generation, predicting the next token distribution at each time step based on the previously generated tokens and the prompt context. The server applies decoding strategies such as greedy decoding, beam search, or sampling with temperature and top-k or top-p constraints to generate coherent and safe alternative expressions. When the generative AI model is provided as a remote service, the server sends the prompt sentence to the remote endpoint and receives the generated text via the communication interface. In either case, the server parses the output to extract at least one alternative expression or summary expression and, optionally, a brief sensitivity comment.

The server organizes the evaluation value, the sensitive portion information, the alternative expressions, and control information into structured data. The structured data may be represented as a record containing fields such as an identifier of the original message, the sensitivity score, the sensitivity category, spans of text identified as sensitive, and one or more alternative or summary expressions. The server also generates control information indicating recommended display behavior on the user terminal, for example, whether to highlight, mask, or annotate the sensitive portions. The server transmits this structured data to the user terminal via the communication interface.

The user terminal receives the structured data and controls the display accordingly. The terminal may, for example, underline sensitive words in red, show a popup warning, and present the suggested alternative expressions below the input field. The user can visually compare the original message and the alternatives. When the user selects an alternative expression, the terminal replaces the original text in the input field with the selected alternative. When the user chooses to edit manually, the user may adopt part of the suggestion or adjust the tone further. The terminal then transmits the revised character information back to the server for re-evaluation.

The server again executes the preprocessing and classification steps on the revised character information. Because the system reuses the loaded models and cached resources, the server can perform this re-evaluation with low latency. If the sensitivity score of the revised message is below the threshold, the server marks the message as acceptable and may generate structured data indicating that no further modification is necessary. The user terminal then can transmit the final approved message to a communication backend or recipient device.

In one concrete example, the user enters the sentence “This project is obviously going to fail” on the terminal. The server tokenizes this sentence, converts it to numerical representations, and inputs it to the classification model. The model outputs a high probability for a sensitive category, indicating that the expression is harsh and could be discouraging. The server then constructs a prompt sentence such as:

“You are a workplace communication assistant. Evaluate how sensitive or potentially hurtful the following message is, and then rewrite it to be respectful and constructive while preserving the original meaning. Message: ‘This project is obviously going to fail.’ Output only: (1) a one-sentence sensitivity comment, and (2) two alternative expressions that are less hurtful.”

The server inputs this prompt sentence to the generative AI model and obtains output such as: “Sensitivity comment: The message is highly negative and may demotivate team members. Alternative 1:‘This project seems to face several challenges, and we should discuss how to address them.’ Alternative 2:‘I am concerned about the current direction of this project and would like to talk about potential improvements.’” The server structures this output and sends it to the terminal, which highlights the original phrase “obviously going to fail” and displays the two alternatives for selection.

The server improves computer technology in several ways. First, the server integrates discriminative and generative models in a unified processing pipeline with specific data structures and thresholds, reducing redundant computations compared to separately deployed systems. By preloading models and reusing tokenization and inference components, the server reduces latency and computational overhead, thereby improving processing speed. Second, the classification model uses continuous sensitivity scores and token-level relevance information to construct more precise prompt sentences, which leads to higher-quality generative outputs and reduces the need for repeated user edits. This improves overall accuracy of sensitivity handling and reduces network traffic and computation associated with multiple communication retries.

Third, the server uses structured data including sensitivity scores, span indices of sensitive text, and display control flags, allowing the terminal to perform fine-grained display control without re-analyzing the text. This separation of analysis and presentation reduces computational load on the terminal and avoids redundant natural language processing on client devices. As a result, the system manages data more efficiently and reduces communication load by transmitting only necessary metadata and generated alternatives instead of full re-analyses.

Fourth, the classification model uses a transformer-based neural network trained with supervised learning on labeled training data. The server generates training data including examples of sensitive and non-sensitive sentences, and the model is trained to minimize a loss function such as cross-entropy between predicted class probabilities and true labels. The server updates model weights using a gradient-based optimization algorithm, such as stochastic gradient descent or an adaptive variant, with backpropagation through time across transformer layers. The server may apply data augmentation techniques, such as paraphrasing or synonym replacement, to increase robustness of the model to variations in wording. By using such training methods, the model can capture complex linguistic patterns beyond simple keyword lists, reducing false positives and false negatives.

Fifth, the generative AI model uses a transformer decoder that predicts each next token based on a history of tokens and attention over the prompt. The server can fine-tune this model on domain-specific corpora of polite and constructive language, using a loss function that penalizes deviation from reference rewrites and encourages content preservation with softened tone. The server may define custom constraints or post-processing rules, such as rejecting outputs that include profanity or disallowed phrases, to enforce safety policies. This combination of neural sequence modeling and rule-based filtering provides a non-conventional processing pathway that is not trivially achievable by human operators or simple rule engines.

The server further applies specific rules for constructing prompt sentences, such as inserting explicit sensitivity labels, marking sensitive spans, and instructing the generative AI model to output in a constrained format. For example, the server may use: “The following workplace message has been evaluated as ‘highly sensitive’ due to negative wording in the marked portion [‘obviously going to fail’]. Please rewrite the entire message to be constructive and supportive, preserving the core meaning. Original message: ‘This project is obviously going to fail.’ Output: 1) one short sensitivity explanation, 2) at least one alternative expression.”

By providing the generative AI model with structured contextual cues, the server improves generation stability and reduces hallucinations, which leads to more predictable and technically useful outputs. This is a technical improvement in the way generative models are controlled and used within a communication system.

In another embodiment, the server assigns identification information to each message and adds control information designating, for example, that certain spans should be masked on the receiving apparatus. The receiving apparatus can then apply masking at render time without re-contacting the server. This architecture reduces server load and network latency by moving some display logic to the client while preserving central control over sensitivity evaluation. The server's use of identifiers and control flags thus yields improved data management and efficient distribution of processing responsibilities.

In yet another embodiment, the server generates summary expressions when the evaluation value falls within a predetermined range, for example when a message is moderately sensitive and overly verbose. The server constructs a prompt sentence instructing the generative AI model to generate a shorter and less aggressive version of the text. Because the server uses the continuous sensitivity score and message length as inputs for this decision, the server can selectively apply summarization only when necessary, thereby saving computation and avoiding unnecessary modifications to messages that are already concise and non-sensitive.

The described system is not limited to a particular messaging platform. The server can be integrated with various communication backends, such as chat systems, email servers, or collaboration platforms, by exposing an application programming interface. The data structures, thresholds, and model architectures can be adjusted to match language, domain, and policy requirements. In some implementations, the server maintains multiple classification models for different languages or organizations and selects an appropriate model based on metadata in the user request.

By combining a transformer-based classification model with a generative AI model through structured prompt sentences and by providing terminals with structured control information, the system improves the underlying computer processes for text analysis, transformation, and display control. The improved accuracy of sensitivity detection, the reduction in latency through efficient model reuse and preloading, and the reduction in redundant processing at the client side are technical effects that go beyond mere automation of human review. The system thereby provides a concrete improvement in computer functionality in the context of network-based communication.

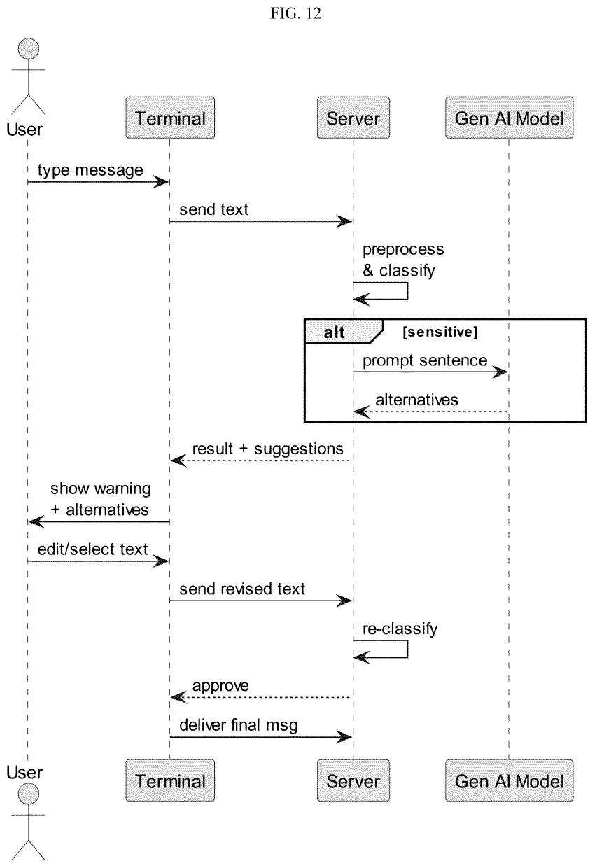

The following describes the processing flow using FIG. 12.

### Step 1:

The user inputs character information on the terminal.

The terminal receives keystrokes or text paste operations as input and stores the current message string in a local buffer of the client application. The terminal may also attach metadata such as user identifier, language setting, and timestamp. The terminal outputs a structured request that includes at least the message string and metadata, and transmits this request to the server via a communication interface, using, for example, an HTTP POST request over a secure transport protocol.

### Step 2:

The server receives the structured request from the terminal.

The server takes as input the network request containing the message string and metadata and passes it to a backend handler executed by a processor. The server parses the request body, validates the format, and extracts the character information and metadata. The server outputs a normalized internal representation, such as a data object that stores the raw text and associated attributes, ready for preprocessing.

### Step 3:

The server preprocesses the character information using a language processing technique.

The server takes as input the raw text in the internal representation and performs normalization operations including converting text to a standard case, removing unsupported control characters, standardizing whitespace, and optionally replacing certain character variants. The server then applies a tokenizer to segment the normalized text into tokens and convert each token into a numerical identifier according to a predefined vocabulary. The server also generates auxiliary arrays such as attention masks and segment identifiers. The server outputs token identifier sequences and corresponding masks as numerical arrays stored in memory.

### Step 4:

The server executes sensitivity classification using a classification model.

The server takes as input the token identifier sequences and attention masks and feeds them into a transformer-based classification model that resides in memory. The server performs a forward pass by computing embedding vectors for each token, applying multiple self-attention and feedforward layers, and obtaining a contextual representation at a designated classification position. The server then applies a final dense layer and an activation function to derive class scores and probabilities representing different sensitivity categories. The server outputs an evaluation value, such as a sensitivity score and the corresponding class label, as numerical and categorical data.

### Step 5:

The server determines whether the character information is sensitive and extracts sensitive portions.

The server takes as input the evaluation value from the classification model and optional token-level relevance indicators, such as attention weights or gradient-based importance scores. The server compares the sensitivity score to a predetermined threshold to determine whether the message is sensitive. When the message is determined to be sensitive, the server analyzes token-level indicators and maps influential tokens back to character offsets in the original text. The server groups contiguous sensitive tokens into spans and extracts those spans as sensitive portions. The server outputs a sensitivity determination result (sensitive or non-sensitive) and a list of sensitive portions, each defined by start and end positions or substrings.

### Step 6:

The server constructs a prompt sentence for a generative AI model.

The server takes as input the original message text, the sensitivity determination result, and the extracted sensitive portions. The server then programmatically combines these elements into a natural language instruction string using a predefined template. The server may insert explicit labels such as “highly sensitive” or “moderately sensitive” and explicitly mark sensitive substrings in the prompt. The server constructs, for example, a prompt sentence of the form: “You are a workplace communication assistant. Evaluate how sensitive or potentially hurtful the following message is, and then rewrite it to be respectful and constructive while preserving the original meaning. Message: ‘[original text]’ Output only: (1) a one-sentence sensitivity comment, and (2) two alternative expressions that are less hurtful.” The server outputs this prompt sentence as a character string ready for input to the generative AI model.

### Step 7:

The server invokes the generative AI model with the prompt sentence.

The server takes as input the constructed prompt sentence and, depending on deployment, either tokenizes it locally or encapsulates it in an API request to a remote generative AI service. When executed locally, the server converts the prompt into token identifiers and processes them through a decoder-type transformer network, computing hidden states with self-attention and feedforward layers and generating next-token probabilities at each step. The server applies a decoding strategy such as beam search or sampling to construct one or more textual outputs that satisfy the constraints expressed in the prompt. When using a remote endpoint, the server sends the prompt and receives the generated text via the communication interface. The server outputs generated text that typically includes at least one sensitivity comment and one or more alternative or summary expressions.

### Step 8:

The server parses the generative output and forms structured data.

The server takes as input the raw generated text returned from the generative AI model. The server applies parsing rules based on the format requested in the prompt, such as splitting by numbered sections, keywords, or line breaks, to separate the sensitivity comment and each alternative expression. The server may trim whitespace, remove extraneous instructions, and normalize the text. The server then combines the evaluation value from the classification model, the sensitive portions, the parsed generative outputs, and display control flags into a structured record. The server outputs structured data that includes fields for message identifier, sensitivity score, sensitivity label, sensitive spans, at least one alternative expression, and recommended display behavior.

### Step 9:

The server transmits the structured data to the terminal.

The server takes as input the structured record containing evaluation, generative results, and control information. The server serializes this record into a transferable format and attaches it as the body of a response message on a network protocol. The server then sends the response to the terminal through the communication interface. The server outputs a network response that delivers both analytical and generative results to the client side in a single transmission.

### Step 10:

The terminal displays the sensitivity result and alternative expressions.

The terminal takes as input the response from the server and deserializes the structured data into client-side objects. The terminal reads fields such as sensitivity score, sensitive spans, and alternative expressions. The terminal then updates the user interface: for example, by highlighting the sensitive spans in the input field, displaying a warning message, and presenting the alternative expressions as selectable options. The terminal outputs an updated visual display on the user's screen, enabling the user to understand and react to the system's analysis.

### Step 11:

The user revises the message based on the displayed information.

The user takes as input the visual feedback and suggested alternatives shown on the terminal. The user may click a suggested alternative expression, causing the terminal to replace the original text in the input field, or manually edit the text to soften wording or clarify meaning. The terminal records the revised character information in its local buffer. The terminal outputs a new request containing the revised text and sends it again to the server to undergo the same classification and generative processing.

### Step 12:

The server re-evaluates the revised character information and approves transmission when safe.

The server takes as input the revised message data sent from the terminal and repeats preprocessing, tokenization, and classification as in previous steps. The server computes a new evaluation value and compares it with the predetermined threshold. When the degree of sensitivity is below the threshold, the server determines that the message is acceptable. The server may then generate minimal structured data indicating approval, or may attach identification and control information for downstream devices. The server outputs an approval result that allows the terminal or associated systems to transmit the message to its intended recipient.

### Step 13:

The terminal transmits the approved message to a communication backend or recipient.

The terminal takes as input the approval result or indication from the server. The terminal then packages the final approved character information, optionally including identifiers or control flags, and sends it to a communication backend such as a messaging server or an email server. The terminal may use an appropriate protocol defined by the backend system. The terminal outputs a final message transmission that reaches the recipient system while reflecting the refinements and safeguards provided by the server's sensitivity and generative processing.

It is also possible to incorporate an emotion engine for estimating the user's emotions. That is, the specific processing unit 290 may estimate the user's emotions using an emotion identification model 59, and perform specific processing based on the estimated emotions.

### EXAMPLE 2

Description follows regarding a flow of the specific processing in an Example 2. The units of the system described below are implemented by the data processing device 12 and the smart device 14. The data processing device 12 is called a “server” and the smart device 14 is called a “terminal”.

In conventional communication systems, servers merely transmit user-generated text data between terminals without deeply analyzing contextual sensitivity of the text. As a result, computing resources at the server and terminals are not effectively utilized to detect and mitigate sensitive or potentially harmful content before it is presented to a user. Existing content filters are typically rule-based keyword filters implemented as simple string comparison logic. Such filters are unable to reliably capture nuanced, context-dependent sensitive expressions, and they lack any integrated mechanism for generating alternative wording or soft summaries using advanced machine learning techniques. Consequently, these systems often either over-block or under-block messages, resulting in a poor balance between user safety and communication efficiency. Furthermore, conventional systems generally apply filtering only at display time, without providing adaptive user interface control that differentiates between a transmitting user terminal and a receiving user terminal based on system-generated sensitivity metadata.

Another problem with conventional systems is that they do not integrate natural language processing pipelines and generative artificial intelligence models into a coherent, feedback-driven control flow at the server. Servers do not combine syntactic parsing, sensitivity scoring, and generation of prompt sentences for a generative model into a unified process that yields both (i) proposal sentences for rephrasing sensitive content at the transmitting user terminal and (ii) soft summary sentences for controlled disclosure at the receiving user terminal. As a result, computing devices cannot provide fine-grained visibility control at the receiving side, such as initially hiding sensitive content while still presenting a machine-generated, gentle summary that informs the recipient of the gist of the message. This leads to suboptimal user interface states, in which either the full content is displayed without sufficient warning or the content is simply blocked without any meaningful contextual indication.

Yet another problem is that conventional architectures do not define, at the processor level, how to structure internal identification information and display control information so that terminals can consistently enforce sensitivity-aware display policies. Without a server-generated sensitivity identifier tied to each message, and without explicit display control metadata, terminals must implement ad hoc heuristics, which can lead to inconsistent behavior across devices and applications. This fragmentation degrades overall system reliability and increases processing overhead on the terminal side, as each client must redundantly implement complex logic.

Accordingly, there is a need for an improved computer-implemented system in which a processor performs integrated natural language parsing, sensitivity determination, prompt-based interaction with a generative artificial intelligence model, and generation of structured control information that governs how transmitting and receiving user terminals present or hide message content. Such a system should leverage computational resources at the server to offload complex analysis from terminals, should generate proposal sentences and summary sentences in a consistent manner, and should provide machine-readable metadata that terminals can use to implement predictable, user-safe display behavior. By addressing these issues, the invention seeks to improve the functioning of the underlying computer system, including its text processing pipeline, inter-device communication, and user interface control logic, rather than merely automating a mental process or abstract policy decision.

The specific processing by the specific processing unit 290 of the data processing device 12 in Example 2 is realized by the following means.

The present invention provides a server comprising a processor configured to parse character information acquired from a user terminal using a natural language processing technique to determine presence or absence of sensitive content and a sensitivity level, to calculate a sensitivity score based on the determination result and predefined evaluation criteria and assign identification information indicating the sensitivity level to the character information, to generate a prompt sentence for a generative artificial intelligence model based on the sensitivity score and the sensitivity level and input the prompt sentence to the generative artificial intelligence model to cause the generative artificial intelligence model to output a proposal sentence that mitigates sensitive expressions in the character information and a summary sentence that summarizes the character information in a softened expression, to store the proposal sentence and the summary sentence in association with the user terminal and generate presentation control information that causes a transmitting user terminal to present the proposal sentence and a receiving user terminal to present the summary sentence, to transmit the character information including the identification information to the receiving user terminal, and to generate display control information that causes the receiving user terminal initially to hide at least a part of the character information based on the identification information and to reveal the hidden character information only in response to a display instruction from a recipient. This enables the computer system to perform integrated, server-side sensitivity analysis and generative response generation, to offload complex language processing from user terminals, to provide structured sensitivity metadata and display control information that drive consistent user interface behavior across devices, and thereby to improve the technical performance and reliability of text communication processes by reducing inappropriate exposure of sensitive content while maintaining efficient and context-aware message delivery.

The term “system” refers to a combination of one or more computing devices, including at least a server and one or more user terminals, that cooperate via a communication network to perform the functions described in the claims.

The term “processor” refers to one or more hardware processing units, such as a central processing unit or a graphics processing unit, and any associated control circuitry configured to execute instructions that cause the system to perform the claimed operations.

The term “user terminal” refers to an electronic device operated by an end user, such as a smartphone, tablet, personal computer, or other computing device, that is capable of sending and receiving character information to and from the server.

The term “character information” refers to data representing text content, including sequences of characters, symbols, or words input by a user or generated by a program, which is processed by the system for analysis and presentation.

The term “natural language processing technique” refers to a software-based text processing method implemented by the processor to analyze human-language text, including at least one of tokenization, part-of-speech tagging, syntactic parsing, or semantic analysis.

The term “sensitive content” refers to portions of character information that are determined by the processor to relate to privacy, emotional harm, personal data, or other context-dependent topics for which cautious handling or limited exposure is desired.

The term “sensitivity level” refers to a categorical or ordinal indication generated by the processor that represents a degree or severity of sensitivity associated with the sensitive content in the character information.

The term “sensitivity score” refers to a numerical or structured value computed by the processor based on predefined evaluation criteria and analysis results, which quantitatively represents the sensitivity level of the character information.

The term “evaluation criteria” refers to a set of rules, thresholds, parameters, or models used by the processor to assess the sensitivity of character information and to determine the sensitivity score and the sensitivity level.

The term “identification information” refers to metadata added by the processor to the character information, including at least an indicator of sensitivity, that is used by the system and user terminals to control display and handling of the character information.

The term “generative artificial intelligence model” refers to a machine learning model capable of generating text in response to an input, including but not limited to a neural network-based language model that outputs proposal sentences or summary sentences based on a prompt sentence.

The term “prompt sentence” refers to text or structured input generated by the processor and supplied to the generative artificial intelligence model, which instructs the model regarding a desired processing task, such as generating a proposal sentence or a summary sentence.

The term “proposal sentence” refers to alternative wording for at least part of the character information, generated by the generative artificial intelligence model in response to a prompt sentence, and intended to mitigate or soften sensitive expressions.

The term “summary sentence” refers to a shortened representation of the character information, generated by the generative artificial intelligence model in response to a prompt sentence, and expressed in softened language that preserves the gist while reducing explicit sensitive details.

The term “presentation control information” refers to data generated by the processor that specifies how and when the proposal sentence and the summary sentence are to be presented by a transmitting user terminal and a receiving user terminal, respectively.

The term “display control information” refers to data generated by the processor that specifies display states and transitions at a receiving user terminal, including whether character information is initially hidden, when it is revealed, and how it is visually presented.

The term “screen control information” refers to a type of control information generated by the processor for a transmitting user terminal, specifying visual emphasis, highlighting, and presentation of alternative candidates in a user interface for character information.

The term “transmitting user terminal” refers to a user terminal operated by a user who composes and sends character information to another user, and which receives proposal sentences and related control information from the server.

The term “receiving user terminal” refers to a user terminal operated by a user who receives character information sent from another user, and which receives summary sentences, identification information, and display control information from the server.

The term “visually emphasize” refers to a manner of display control by which the processor causes a user interface on a terminal to distinguish sensitive portions of character information using visual effects such as highlighting, underlining, color changes, or other stylistic modifications.

The term “alternative candidate” refers to a proposal sentence or part of a proposal sentence presented by a transmitting user terminal, which can be selected by a user to replace or modify a corresponding portion of the original character information.

The term “hide” refers to a display state in which at least part of the character information is not rendered or is obscured on a user interface of a terminal, such that a user cannot read the hidden content without taking an additional explicit operation.

The term “display instruction” refers to an explicit user operation received at a receiving user terminal, such as a touch, click, or command, which causes the terminal to change a display state from hidden to visible for at least part of the character information.

In one embodiment, a server cooperates with one or more terminals operated by users to implement a sensitivity-aware text communication system. The server includes at least one processor and a memory. The processor executes programs that implement natural language processing, sensitivity scoring, prompt sentence generation, and inference using a generative AI model. The memory stores executable instructions, sensitivity dictionaries, trained model parameters, and message metadata including sensitivity-related identifiers. The server communicates with terminals via a network interface over wired or wireless networks.

A terminal includes a processor, a memory, a display device such as a liquid crystal display or organic light-emitting diode display, an input device such as a touch panel or keyboard, and a communication interface. The terminal executes a messaging application that sends character information to the server and receives sensitivity analysis results, proposal sentences, and summary sentences. The messaging application renders underlined or highlighted text, selectable alternative candidates, and hidden message placeholders according to control information output by the server.

The server uses a natural language processing library such as a statistical or rule-based parser (for example, a dependency parser implemented in a general-purpose NLP library) to process character information acquired from terminals. The server tokenizes character strings, performs part-of-speech tagging, lemmatizes tokens, and constructs syntactic parse trees. The server then maps tokens and their syntactic contexts to a structured representation such as a sequence of token feature vectors. Each token feature vector can include categorical features (e.g., part-of-speech, dependency relation, named entity type), lexical features (e.g., lemma, subword units), and manually defined sensitivity indicators (e.g., flags for “privacy-related term,” “insult term,” or “health-related term”).

The server stores sensitivity-related lexical resources in a data store, for example a relational database or key-value store. The server maintains multiple lexicons for different sensitivity categories, such as privacy, mental health, violence, and discrimination. Each lexicon entry may be associated with a base weight and category labels. The server retrieves these weights and labels when evaluating the sensitivity of a given message. By encoding such structured dictionaries, the server enables deterministic, repeatable sensitivity scoring that can be combined with probabilistic outputs from the generative AI model.

The server uses a generative AI model implemented as a neural network, for example a Transformer-based sequence-to-sequence language model. The generative AI model includes multiple layers of self-attention and feed-forward networks, with learned parameters stored in the server memory. The server provides the model with input sequences composed of a prompt sentence concatenated with the user's character information. The server uses a tokenizer, such as a byte-pair encoding tokenizer or a unigram subword tokenizer, to convert text into token IDs. The server then feeds the token IDs into the model's embedding layer, applies positional encodings, and processes them through multiple attention layers. The server obtains output token distributions at each time step and uses decoding algorithms such as greedy decoding or beam search to generate proposal sentences and summary sentences.

The server trains the generative AI model prior to deployment and can further fine-tune it using supervised learning on a dataset of messages annotated with sensitivity labels and human-provided rewrites. The server minimizes a loss function, for example a cross-entropy loss between predicted tokens and target tokens, and updates model weights using gradient-based optimization such as stochastic gradient descent or Adam optimization. The server may apply regularization techniques, such as dropout on attention layers and layer normalization, to improve generalization and stability. The server can augment training data using data augmentation methods such as synonym replacement, back-translation, or noise injection, thereby improving model robustness to diverse user inputs.

The server defines specific internal criteria for sensitivity scoring. The server computes a base score for each token based on dictionary weights and multiplies or adds modifiers depending on syntactic roles, surrounding context, and sentiment polarity. The server can use a sentiment analysis module to compute a scalar sentiment value, for example in the range from negative to positive, and incorporate this value into the sensitivity score via a weighted combination. The server then aggregates token-level contributions to produce a message-level sensitivity score. The server compares this score with predefined thresholds stored in configuration data to assign a discrete sensitivity level such as “none,” “low,” “medium,” or “high.” This scoring procedure is not a simple keyword check; it integrates structural features and contextual sentiment to provide higher accuracy and lower false positives or false negatives compared to conventional filters.

The server uses the sensitivity score and sensitivity level to construct a prompt sentence for the generative AI model. For example, the server can generate the following prompt sentence for sensitivity analysis: “Analyze the following user message and determine whether it contains sensitive content related to privacy, mental health, harassment, or other personal issues. Return a classification in terms of ‘none’, ‘low’, ‘medium’, or ‘high’and briefly explain the reasons. Message: [user message].”

The server can generate the following prompt sentence for rewriting: “Rewrite the following message in softer, more neutral language without changing its core meaning. Avoid wording that could hurt the recipient's feelings. Provide two alternative versions. Message: [user message].”

The server can also generate the following prompt sentence for summarization: “Summarize the following message in 1-2 sentences using gentle, non-triggering language so that a reader understands the main point without detailed sensitive information. Message: [user message].”

The server concatenates these prompt sentences with the actual message content and encodes them as token sequences for input to the generative AI model. By structuring prompts in this way, the server constrains the model's behavior and ensures consistent outputs that conform to required formats and tone, thereby improving computational predictability and reducing the need for downstream corrections.

The server assigns identification information to each piece of character information. The identification information can include fields such as a sensitivity flag, the sensitivity level, category labels, and a message identifier. The server stores this information within a message record in a database. For example, a message record may include fields for sender identifier, receiver identifier, timestamp, raw text, normalized text, sensitivity score, sensitivity level, and pointers to the stored proposal and summary sentences. This structured storage improves data management by enabling efficient retrieval and filtering based on sensitivity metadata, and also reduces computation by avoiding redundant analysis when the same message is re-accessed or displayed multiple times.

The terminal uses communication protocols such as HTTPS or WebSocket to exchange data with the server. The terminal sends character information and contextual metadata, such as conversation identifiers, to the server. The terminal receives back sensitivity-related metadata, proposal sentences, summary sentences, and various display control instructions. On the sending side, the terminal uses the received information to control visual rendering. For example, the terminal can underline words marked as sensitive, change their color, or show an icon near the input field when the sensitivity score exceeds a threshold. The terminal can display the proposal sentences as buttons or selectable items; when the user taps one, the terminal replaces or inserts the corresponding text into the input field. This reduces the number of input operations that the user must perform and allows rapid adoption of safer wording.

On the receiving side, the terminal reads the identification information and display control information provided by the server. When the sensitivity flag is set and the sensitivity level exceeds a threshold, the terminal does not render the full message text in the initial view. Instead, the terminal renders a placeholder, such as a message bubble showing “This message may contain sensitive content,” and may also render the summary sentence below this placeholder. The terminal allows the user to reveal the full content only after a specific user action such as clicking a “Show message” button. This behavior is driven by server-generated metadata, not by ad hoc client logic, which improves consistency across different types of terminals.

The server improves processing efficiency by performing resource-intensive tasks such as syntactic parsing and neural network inference centrally. The server uses optimized linear algebra libraries, vectorized operations, and possibly specialized hardware accelerators such as graphics processing units or tensor processing units to compute attention scores, matrix multiplications, and activation functions in the generative AI model. Compared with a system where each terminal independently runs heavy models, the centralization reduces overall computation cost and network traffic because the server can reuse cached results for similar messages and models can be updated in a single location. Moreover, by precomputing summary sentences and proposal sentences at the server, the terminals can simply render these results without performing complex text generation, which reduces latency on devices with limited computational capabilities.

The server achieves technical improvements over conventional systems in several ways. First, the server reduces misclassification errors by combining rule-based lexical scoring with neural-model-based contextual evaluation. This hybrid approach allows the system to detect subtle expressions that would be missed by pure keyword-based filters and to down-weight benign uses of potentially sensitive terms when the context is neutral. Second, the server enhances communication throughput and responsiveness by structuring sensitivity metadata in a compact format and transmitting only essential control information and generated text, rather than raw intermediate model states. Third, the server decreases network and processing overhead by avoiding repetitive analysis: once a message has its sensitivity metadata calculated, the server stores and reuses this information during subsequent accesses, such as when a user scrolls through a conversation history.

The server differs from manual or purely policy-based systems because it implements specific algorithms for sensitivity scoring and generative control that are not practical for humans to execute in real time. For example, the server can evaluate each token using high-dimensional vector operations, aggregate attention patterns across multiple layers, and compute probability distributions over thousands of vocabulary items in milliseconds. The server applies non-intuitive weighting rules derived from machine learning, such as attention weights, gradient-based importance scores, or learned embeddings, which do not correspond to any simple manual rules. As a result, the system's processing is not a mere automation of human judgment, but a technically distinct technique that leverages the unique capabilities of computing hardware.

In another embodiment, the server uses a different neural architecture, such as a recurrent neural network with long short-term memory cells or a convolutional sequence model, to implement the generative AI model. The server may employ an encoder-decoder framework, where an encoder converts the input message into a context vector and a decoder generates the output sequence conditioned on that vector and the prompt. The server can train this architecture using teacher forcing and backpropagation through time, minimizing a loss function that includes both reconstruction error and auxiliary sensitivity prediction error. By including the auxiliary loss, the model learns internal representations that correlate with sensitivity characteristics, which further improves the quality of the proposal and summary sentences.

In yet another embodiment, the server implements multiple generative AI models specialized for different domains or languages. The server can select a model based on user preferences, message language detection results, or conversation context. The server can dynamically adjust prompt sentences to account for different cultural norms or regulatory requirements by including region or domain indicators in the front of the prompt. This modularity allows the system to scale across different applications and jurisdictions while maintaining consistent computational behavior.

The server can further implement adaptive thresholding mechanisms. For instance, the server can adjust sensitivity thresholds per user or per conversation based on historical feedback. If a user frequently overrides warnings and chooses to send messages unchanged, the server may slightly increase thresholds to reduce unnecessary warnings, while maintaining safety criteria. Conversely, if a user commonly selects proposal sentences and acknowledges sensitivity warnings, the server can lower thresholds to provide earlier interventions. Such adaptation can be implemented using simple online learning algorithms or reinforcement learning signals, computed directly by the processor based on aggregated user actions.

The terminal can support various alternative user interface designs without affecting the core server-side algorithms. For example, one terminal embodiment may display proposal sentences as inline text toggles, whereas another may show them in a separate pane. Similarly, the way in which hidden sensitive content is visually represented can vary across platforms, such as using blurred text, collapsed panels, or explicit warning icons. In all these cases, the basic control information generated by the server remains the same, thus decoupling model logic from device-specific presentation and improving maintainability of the overall system.

By integrating structured sensitivity scoring, advanced generative AI model inference, and metadata-driven display control, the server and terminals together provide a technical solution that enhances the functioning of the communication system. Processing speed is increased by centralized use of optimized neural computation; accuracy is improved by combining rule-based and neural context evaluation; data management is enhanced through structured storage of sensitivity metadata; and communication load is reduced by selectively transmitting compact summaries and control codes instead of redundant raw analysis data. This causal chain between specific computational steps and concrete system-level effects demonstrates that the invention goes beyond abstract idea implementation and constitutes a technical improvement in computer-based text communication.

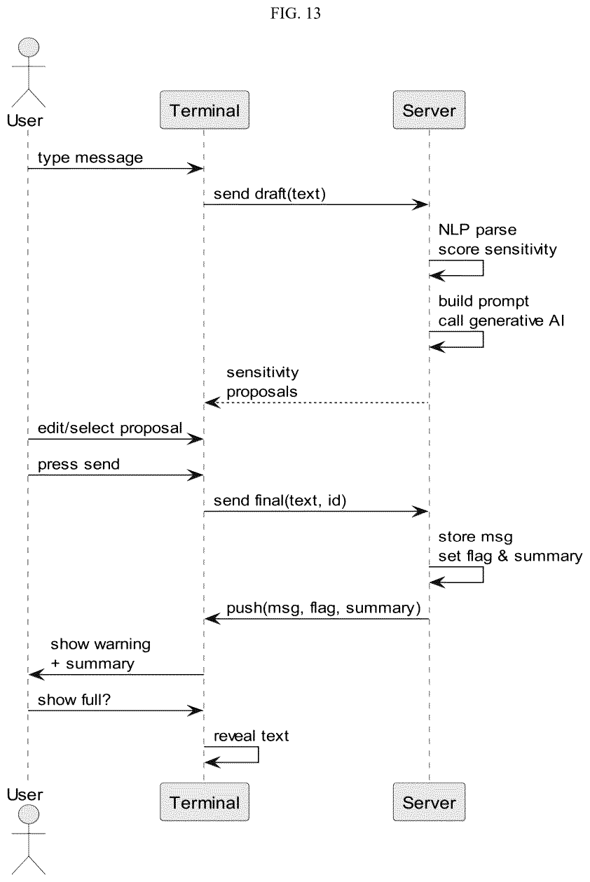

The following describes the processing flow using FIG. 13.

### Step 1:

User inputs character information on the terminal.

User operates the messaging application on the terminal and enters text using a touch screen keyboard or hardware keyboard. The input is a sequence of characters forming a draft message, along with contextual data such as a conversation identifier and user identifier. Terminal temporarily stores this draft message in working memory as a text buffer and associates it with a draft message ID. Terminal generates a data object that contains the draft text, the draft message ID, and context metadata as output for the next step.

### Step 2:

Terminal transmits the draft message to the server.

Terminal takes the draft message object as input, serializes it into a structured format such as JSON, and establishes a secure network connection using a protocol such as HTTPS. Terminal sends a request including the draft text, user identifier, and conversation identifier to a designated analysis endpoint on the server. The output of this step is a network packet containing the serialized message data delivered to the server.

### Step 3:

Server performs basic text preprocessing and syntactic parsing.

Server receives the network packet as input and deserializes the JSON payload to extract the raw text string and metadata. Server uses a natural language processing library (for example, a dependency parser in a general-purpose NLP toolkit) to perform tokenization, part-of-speech tagging, lemmatization, and syntactic dependency parsing on the text. Server converts the string into a list of token objects, each containing fields such as surface form, lemma, part-of-speech tag, and dependency relation. The output is a structured representation of the message, including the token list and parse tree, stored in memory for further analysis.

### Step 4:

Server computes rule-based sensitivity indicators.

Server takes the token list and parse tree as input and accesses sensitivity dictionaries stored in a database or configuration store. Server compares each token lemma and some n-gram combinations against entries in category-specific lexicons (for example, privacy-related terms, mental health terms, insult terms). Server calculates a base sensitivity value for each matched token according to weights stored in the lexicon and modifies these values based on syntactic roles (for example, subject versus object) and nearby negation or intensity markers detected in the parse tree. Server then aggregates token-level values to form preliminary category-wise scores and an overall preliminary sensitivity score. The output is a sensitivity indicator structure that includes per-token flags, per-category scores, and an initial overall sensitivity score.

### Step 5:

Server performs contextual evaluation using a generative AI model.

Server uses the original text, the preliminary sensitivity indicator structure, and the parse result as input to construct a context-aware query for the generative AI model. Server generates a prompt sentence such as: “Analyze the following user message and determine whether it contains sensitive content related to privacy, mental health, harassment, or other personal issues. Return a classification in terms of ‘none’, ‘low’, ‘medium’, or ‘high’and briefly explain the reasons. Message: [user message].”

Server tokenizes the prompt and the message using a subword tokenizer, converts them into token IDs, and feeds them into the generative AI model, which is implemented as a multi-layer neural network (for example, a Transformer-based language model). Server executes matrix multiplications and attention operations on the model's processing unit (CPU or GPU) to produce output token distributions. Server decodes the model output into a text response and extracts a sensitivity level (“none,” “low,” “medium,” or “high”) and explanatory phrases. The output is an AI-based sensitivity evaluation that includes a sensitivity level and highlighted rationale phrases.

### Step 6:

Server determines final sensitivity score and assigns identification information.

Server takes as input the rule-based preliminary scores and the AI-based sensitivity evaluation. Server combines them using a predefined algorithm, for example a weighted average or decision rules that prioritize high-confidence neural outputs while correcting obvious lexical matches. Server re-computes an overall numeric sensitivity score and maps this score to a discrete sensitivity level. Server creates identification information that includes a sensitivity flag, the final sensitivity level, category labels, and a unique message identifier. The output is a finalized sensitivity metadata object associated with the message.

### Step 7:

Server generates a prompt sentence for proposal sentence creation and obtains proposed rewrites.

Server uses the original message text and the final sensitivity metadata as input. Server constructs a prompt sentence such as: “Rewrite the following message in softer, more neutral language without changing its core meaning. Avoid wording that could hurt the recipient's feelings. Provide two alternative versions. Message: [user message].”

Server tokenizes this prompt plus the message, encodes them as token IDs, and feeds them into the generative AI model. Server runs forward propagation through embedding layers, attention layers, and feed-forward layers, and then performs sequence decoding (for example, beam search) to generate one or more proposal sentences that mitigate sensitive expressions. The output is a set of alternative proposal sentences, each stored as text associated with the original message ID.

### Step 8:

Server generates a prompt sentence for summary sentence creation and obtains a soft summary.

Server takes the original message and the sensitivity metadata as input for summarization. Server builds a prompt sentence such as: “Summarize the following message in 1-2 sentences using gentle, non-triggering language so that a reader understands the main point without detailed sensitive information. Message: [user message].”

Server again tokenizes the prompt and message, encodes them, and executes the generative AI model to output a summarized sequence of tokens. Server decodes these tokens into a summary sentence that describes the gist of the message in softened language. The output is a soft summary sentence stored in association with the message ID and the identification information.

### Step 9:

Server stores message data and generates control information for terminals.

Server takes as input the original text, the final sensitivity metadata, the proposal sentences, and the summary sentence. Server writes a message record into persistent storage, such as a relational database, with fields including sender identifier, receiver identifier, timestamp, text, sensitivity flag, sensitivity level, and references to stored proposals and summary. Server also generates two kinds of control information: screen control information for the transmitting terminal (specifying which portions to highlight and how to present alternatives) and display control information for the receiving terminal (specifying hidden/visible states and handling of the summary). The output consists of stored message records in the database and ready-to-send control information objects.

### Step 10:

Server sends analysis results to the transmitting terminal.

Server uses the control information for the transmitting side and the proposal sentences as input to formulate a response to the original draft analysis request. Server packages into a response object the sensitivity flag, sensitivity level, locations of sensitive phrases, one or more proposal sentences, and related screen control instructions (for example, instructions to underline specific character ranges). Server serializes this object and sends it back over the network using HTTPS to the terminal that originated the draft. The output is a network response containing structured analysis results delivered to the transmitting terminal.

### Step 11:

Terminal presents sensitivity information and proposal sentences to the user.

Terminal receives the server response as input and deserializes the data. Terminal reads the sensitivity flag and phrase locations and modifies the text rendering in the message input field: for example, terminal underlines sensitive words and changes their color. Terminal also reads the proposal sentences and builds interactive UI elements such as selectable chips or buttons, each containing one proposal sentence. When user taps a proposal, terminal replaces or merges corresponding parts of the draft message text. The output of this step is an updated on-screen representation of the draft message and a user interface that allows easy selection of safer wording.

### Step 12:

User confirms the final message and instructs the terminal to send it.

User reviews the highlighted sensitive portions and may select one of the proposal sentences. User edits the text directly if desired. When the user is satisfied, user taps a “Send” control in the application. The input to this step is the current draft text as displayed and the available proposals. The output is a finalized message text chosen by the user and a send command that the terminal will use to initiate final transmission.

### Step 13:

Terminal transmits the finalized message and sensitivity identification to the server.

Terminal takes the finalized text and associated identification information (if provided in the previous response) as input. Terminal constructs a send request that includes the text, sender identifier, receiver identifier, conversation identifier, and any attached sensitivity metadata. Terminal serializes this data into a request body and sends it via HTTPS to a message delivery endpoint on the server. The output is a network request that delivers the final message and its metadata to the server for storage and forwarding.

### Step 14:

Server validates, finalizes, and stores the message for delivery.

Server receives the finalized message request as input. If the identification information is absent or outdated, server can optionally re-run the analysis steps (parsing, scoring, and generative evaluation) in a faster path to confirm or update sensitivity metadata. Server then stores the final message record in the database, associating it with sender, receiver, and sensitivity identification information. Server uses the receiver identifier and conversation identifier to determine the target receiving terminal(s). The output is a persistent message record ready for delivery and a routing decision for downstream communication.

### Step 15:

Server sends the message and display control information to the receiving terminal.

Server uses the stored message record and display control information as input. Server forms a push payload including the text, identification information (sensitivity flag, sensitivity level), and the summary sentence, along with instructions indicating whether to hide the full text on initial display. Server sends this payload to the receiving terminal using a push mechanism such as a push notification service or a persistent connection (for example, WebSocket). The output is a push message delivered to the receiving terminal.

### Step 16:

Terminal on the receiving side controls initial display based on sensitivity metadata.

Terminal receives the push payload as input and stores the message and metadata locally. Terminal checks the sensitivity flag and sensitivity level. If the message is marked as sensitive above a threshold, terminal does not render the full message text in the chat view. Instead, terminal renders a placeholder text (for example, “This message may contain sensitive content”) and optionally shows the summary sentence below it. Terminal sets an internal state flag indicating that the full content is hidden but available. The output is a user interface where the original text is hidden and only warning and summary content are visible.

### Step 17:

User decides whether to reveal the sensitive content on the receiving terminal.

User observes the placeholder and the summary sentence. User may decide to reveal the full content or leave it hidden. When user taps a “Show message” control, the input is the user interaction event associated with the specific message identifier. Terminal reads the internal hidden state and switches the display state to “visible,” causing the full text to be retrieved from local storage and rendered in the chat view. If user chooses not to reveal it, the state remains “hidden” and only the summary is shown. The output is either a fully revealed message display or a continued hidden state, depending on the user's action.

### Step 18:

Server and terminals optionally adapt thresholds and behavior based on accumulated interaction data.

Server takes as input logs of user actions, such as how often proposal sentences are accepted, how frequently sensitive messages are revealed, and how many times warnings are overridden. Server processes these logs using statistical analysis or online learning methods to adjust evaluation criteria or sensitivity thresholds stored in configuration. Terminals may also update local preferences based on server instructions. By computing new parameter values and distributing them to processing modules, the system gradually adapts to user behavior. The output of this step is updated configuration data that changes how future messages are scored, flagged, and displayed, leading to refined sensitivity control and improved overall system performance.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In contemporary communication systems, computing devices process user-generated text and voice messages and deliver them to recipients with minimal semantic transformation. Conventional content moderation and sentiment analysis engines typically classify messages as acceptable or unacceptable, or label them with coarse sentiment categories. These systems are usually designed as one-shot classifiers: they detect potential issues and either block the message, append a simple warning, or log the event for later review. As a result, several technical problems arise in the way computers process, transform, and present sensitive or emotionally intense information.

First, traditional natural language processing pipelines on servers do not tightly integrate sensitivity analysis, emotion analysis, and generative language transformation in a feedback-controlled manner. A typical pipeline extracts features, runs a classifier, and returns a label. The pipeline does not use the classification output to drive a generative model with a structured prompt, does not re-evaluate the generated text, and does not iteratively adjust the output to satisfy quantitative constraints on sensitivity and emotion. Accordingly, the computing system has no mechanism for automatically transforming highly sensitive or emotionally charged text into a bounded-sensitivity version while maintaining the informational content, and no mechanism for verifying, in a loop, that the transformation actually meets defined machine-evaluable thresholds.

Second, conventional messaging backends do not treat sensitivity and emotion metrics as first-class control signals for presentation logic on receiving devices. Existing systems may attach simple flags, but they generally do not generate and propagate rich display control flags that encode how the content should be initially rendered (e.g., hidden, summarized, or fully displayed) at the receiving terminal, nor do they use these flags in a systematic way to control user interface behavior. As a result, the computing system cannot programmatically enforce an initial non-display of sensitive content, nor can it reliably present a low-impact summary first and reveal the original content only in response to an explicit user action at the receiver side.

Third, conventional systems that use generative models typically apply them in a static, user-driven fashion, where a user explicitly submits text to a generative model to obtain an alternative phrasing. In such designs, the backend does not compute sensitivity scores and emotional intensities as quantitative constraints, does not automatically compose prompt sentences that encode these constraints, and does not coordinate the entire flow—from initial analysis, through prompt construction, to iterative regeneration and final UI-level display control—under a unified processing logic executed by a server processor. Consequently, the overall human-computer interaction is fragmented, and the computer system cannot reliably and automatically provide contextual, sensitivity-aware transformations optimized for both the sender and the receiver.

Fourth, from a computer-technical perspective, these limitations manifest as inefficient and suboptimal use of processing and network resources. Without a unified server-controlled pipeline that (i) computes numeric sensitivity and emotion scores, (ii) drives a generative model via structured prompt sentences, (iii) re-evaluates generated outputs, and (iv) encodes rendering instructions as machine-readable flags, the system cannot consistently avoid transmitting or displaying unnecessarily harmful content. This results in repeated manual corrections, redundant network requests for trial-and-error rewrites by users, and increased load on moderation subsystems, all of which degrade the operational efficiency and robustness of the communication infrastructure.

Therefore, there is a need for a computer-implemented system in which a server processor automatically parses messages, quantifies sensitivity and emotional intensity, constructs and sends prompt sentences to a generative AI model to obtain softened or summarized variants, re-evaluates the variants against numeric thresholds, assigns identification information and display control flags based on the evaluation, and coordinates sender-side suggestion presentation and receiver-side display behavior. Such a system should improve how computing resources are orchestrated to manage sensitive and emotional content, and should provide an integrated, machine-controlled feedback loop that reduces the emotional impact on recipients while preserving essential information content.

The specific processing by the specific processing unit 290 of the data processing device 12 in Application Example 2 is realized by the following means.

The present invention provides a server comprising a processor configured to parse input information received from a user terminal using natural language processing to determine sensitive content and emotional features, to compute a sensitivity degree and an emotional degree of the input information as numerical scores based on a predetermined evaluation criterion, to assign identification information and at least one display control flag to the input information in accordance with the computed scores so as to control a presentation mode of corresponding transmission information at a receiving user terminal, to construct and input a prompt including a prompt sentence to a generative AI model based on the computed scores and the emotional features so as to cause the generative AI model to generate a corrected sentence or a summary sentence that converts the input information into a softened expression or summarizes a main point of the input information with reduced emotional impact, to re-evaluate the corrected sentence or the summary sentence using the natural language processing to calculate updated sensitivity and emotional scores and, when at least one of the updated scores exceeds a predetermined threshold, to input an additional prompt including an additional prompt sentence to the generative AI model to instruct regeneration until the updated scores satisfy the predetermined threshold, and to provide the corrected sentence or the summary sentence and the display control flag to the user terminal so that a sending-side user can selectively adopt the corrected sentence or the summary sentence as the transmission information and a receiving-side user terminal can, based on the display control flag, initially hide sensitive content and selectively display the sensitive content in response to an explicit viewing instruction from a receiving-side user. This enables a computing system to automatically and iteratively transform user-generated messages into machine-verified, sensitivity-bounded variants, to encode presentation behavior as machine-readable control flags, and to coordinate sender-side suggestion presentation and receiver-side initial non-display and selective reveal of sensitive content, thereby improving the technical operation of message processing pipelines, reducing unnecessary transmission and rendering of highly sensitive text, and enhancing robustness and efficiency of computer-implemented communication services.

The term “system” refers to an arrangement of one or more computing devices, storage devices, communication interfaces, and associated software components that cooperatively execute functions described herein.

The term “processor” refers to a hardware processing unit or a combination of hardware processing units, such as a central processing unit or a programmable logic device, that executes instructions to perform the described operations.

The term “user terminal” refers to a computing device operated by a user, such as a general-purpose computer, a mobile communication device, or another network-enabled device, that transmits input information to and receives output information from the server.

The term “server” refers to a computing device or a group of computing devices that include the processor and are configured to receive, process, and transmit data over a communication network according to the methods described herein.

The term “input information” refers to data representing content provided by a user through the user terminal, including text obtained directly from user input and text obtained by converting user speech into text.

The term “transmission information” refers to content that has been finalized by the processor for delivery from a sending-side user terminal to a receiving-side user terminal after processing, transformation, or selection as described herein.

The term “receiver” refers to a user or process that receives the transmission information via a receiving-side user terminal.

The term “natural language processing” refers to a set of computational techniques for analyzing, understanding, or manipulating human language data in textual form, including tokenization, syntactic parsing, semantic analysis, sentiment analysis, and emotion analysis.

The term “sensitive content” refers to portions of the input information that are determined, based on computational analysis, to have a potential to cause discomfort, emotional distress, or other negative psychological impact on a receiver.

The term “emotional features” refers to computationally derived indicators of emotional tone in the input information, including but not limited to anger, sadness, joy, fear, or other affective states and their associated intensities.

The term “sensitivity degree” refers to a numerical representation, computed by the processor, indicating a level or magnitude of sensitivity of the input information according to a predetermined evaluation criterion.

The term “emotional degree” refers to a numerical representation, computed by the processor, indicating a level or magnitude of emotional intensity of the input information according to a predetermined evaluation criterion.

The term “evaluation criterion” refers to a rule set or algorithmic specification used by the processor to convert analysis results into quantitative scores for sensitivity and emotion.

The term “score” refers to a numerical value computed by the processor that quantifies at least one aspect of the input information, such as sensitivity degree or emotional degree.

The term “identification information” refers to data, such as an identifier or code, that uniquely or distinguishably associates the transmission information with corresponding control information, analysis results, or storage records.

The term “display control flag” refers to a machine-readable indicator attached to the transmission information that specifies how the content should be initially rendered or hidden on a receiving-side user terminal.

The term “display mode” refers to a manner in which information is visually or otherwise presented on a user terminal, including full display, partial display, summarized display, or non-display.

The term “non-display mode” refers to a mode in which content or a portion of content is not directly presented on a user terminal screen, but may instead be replaced with a placeholder, warning, or summary.

The term “generative AI model” refers to a computational model that uses machine learning to generate natural language text in response to input data, including prompt information, and that can produce corrected, rewritten, or summarized versions of text.

The term “prompt” refers to input data provided to the generative AI model that includes instructions and context for generating an output, and may include one or more prompt sentences.

The term “prompt sentence” refers to a textual instruction within a prompt that specifies to the generative AI model how to transform or generate text, such as requesting softening, rewriting, or summarization.

The term “candidate sentence” refers to a text output generated by the generative AI model in response to a prompt, prior to being finally adopted as transmission information.

The term “corrected sentence” refers to a text output generated by the generative AI model that represents a rewritten version of the input information with modified wording intended to reduce sensitivity or emotional intensity while preserving core meaning.

The term “summary sentence” refers to a text output generated by the generative AI model that concisely represents a main point of the input information while being configured to reduce emotional impact.

The term “softened expression” refers to a wording style in which potentially harsh or emotionally intense language is replaced by more neutral or considerate language while preserving essential informational content.

The term “main point” refers to essential information or core meaning contained in the input information as determined by an analysis or summarization process.

The term “emotional impact” refers to an effect that the content of a message is expected to have on a receiver's emotional state, as inferred or quantified by the system.

The term “updated sensitivity and emotional scores” refers to numerical values computed by the processor for the corrected sentence or the summary sentence, using the same or similar evaluation criteria as applied to the original input information.

The term “predetermined threshold” refers to a value or set of values defined in advance and used by the processor as a criterion to decide whether the sensitivity or emotional degree of a text is acceptable or requires further modification.

The term “additional prompt” refers to a prompt that is provided to the generative AI model after an initial generation, based on re-evaluation of the generated text, to instruct the model to regenerate or further refine the output.

The term “viewing instruction” refers to an explicit operation performed by a receiving-side user, such as selecting a user interface element, that commands the receiving-side user terminal to display content that is initially hidden.

The term “sending-side user” refers to a user operating a user terminal that generates the input information which is processed and potentially transformed before being transmitted.

The term “receiving-side user” refers to a user operating a user terminal that receives the transmission information and interacts with display options as controlled by the display control flag.

In one embodiment, a server implements the claimed system as a network-accessible processing platform that interacts with a plurality of terminals operated by users. The server comprises at least one processor, a main memory, persistent storage, and a network interface. The processor executes program modules that implement natural language processing, sensitivity and emotion scoring, prompt generation, interaction with a generative AI model, and display control logic. The terminals comprise computing devices such as smartphones, tablet devices, or personal computers, each including at least one processor, a display device, an input device such as a keyboard or touch screen, and optionally a microphone and speaker for voice interaction.

The server executes software implemented, for example, in a high-level programming language running on an operating system. The server loads natural language processing libraries, such as a syntactic parsing library and a sentiment/emotion analysis library, from storage into memory. The server further maintains a data store, such as a relational database or key-value store, that records message objects, identification information, sensitivity scores, emotional scores, and display control flags.

The server receives input information from a terminal as structured data that includes at least a text field and metadata fields. The terminal transmits the input information over a network using a communication protocol. In a voice-based variant, the terminal applies a speech recognition engine, such as a neural-network-based acoustic model combined with a language model, to convert user speech into text before transmitting the text to the server. The speech recognition engine runs locally on the terminal or remotely on an auxiliary server and outputs text sequences as input information.

The server applies a natural language processing module to the input information. The server uses a tokenizer and a part-of-speech tagger to segment the text into tokens and assign syntactic categories. The server then applies a syntactic dependency parser to compute a dependency tree that encodes grammatical relations between tokens. The server stores token-level features, including token identifiers, lemmas, part-of-speech tags, and dependency relations, into an internal data structure such as an array of token records or a table in memory.

The server computes sensitivity-related features from the parsed text. The server maintains a sensitivity lexicon data structure, such as a hash map, that associates normalized word forms with sensitivity weights for different categories, for example, insult, profanity, threat, or negative evaluation. The server iterates through the tokens of the input information and, for each token, looks up corresponding entries in the sensitivity lexicon. When the server detects a match, the server increments category-specific counters and accumulates a weighted sensitivity score for the message. The server may also compute additional features such as the position of sensitive terms within the sentence, the presence of negations, and the grammatical role of the sensitive terms, in order to refine the evaluation.

The server computes a sensitivity degree by applying an evaluation function to the features. The server, for instance, uses a linear or non-linear aggregation formula to map raw counts and positions into a normalized numerical score. The server may implement this evaluation function using a numerical library that operates on arrays or tables, so that the scoring can be efficiently applied to large volumes of messages.

The server computes emotional features and an emotional degree separately from the sensitivity degree. The server applies a sentiment and emotion analysis model to the token stream or sentence representation. In one embodiment, the server uses a neural network classifier that operates on distributed representations of tokens. The classifier may be implemented as a recurrent neural network, a convolutional neural network, or a transformer-based network pre-trained on large-scale text corpora and fine-tuned on labeled emotion datasets. The server passes the input information through an embedding layer that converts tokens into fixed-dimensional vectors, then through multiple hidden layers with non-linear activation functions, and finally through an output layer that produces probabilities over emotion categories such as anger, sadness, joy, fear, and neutrality. The server converts these probabilities into an emotional degree by taking the maximum probability or by computing a weighted combination of probabilities.

The server stores the computed sensitivity degree and emotional degree in an internal message object that also holds the text and parsed features. The server assigns identification information to the message object by generating a unique identifier, for example using a pseudo-random or time-based identifier generation algorithm. The server stores the identifier and associated scores into a database record indexed by the identifier.

The server determines one or more display control flags based on the sensitivity degree and emotional degree. The server compares the sensitivity degree to one or more thresholds that define categories such as low, medium, and high sensitivity. The server also compares the emotional degree against thresholds that indicate high-intensity anger, sadness, or other emotions. When the sensitivity degree or emotional degree exceeds a predetermined threshold, the server sets a display control flag in the message object. The display control flag indicates, for example, that the message should initially be hidden on the receiving terminal, that only a summary should be shown, or that a warning dialog should be displayed before revealing the full text.

The server constructs a prompt sentence for a generative AI model based on the computed scores and the emotional features. The server retrieves the original text of the input information and embeds it into a template that specifies the transformation to be performed. For example, the server may generate a prompt sentence in the form:

“Please rewrite the following message in softer and polite language while preserving its essential meaning: ‘[original message]’.”

or

“The following message is emotionally harsh. Provide a more considerate version that avoids hurting the receiver: ‘[original message]’.”

or

“Summarize the following message in gentle and neutral wording so that the main point is retained but the emotional impact is reduced: ‘[original message]’.”

The server may augment the prompt sentence with explicit references to the detected emotion, such as:

“The current emotional tone is anger. Please reduce aggression in the following sentence: ‘[original message]’.”

The server combines the prompt sentence with other control parameters, such as temperature, maximum length, and style constraints, into a prompt structure and transmits it to a generative AI model.

The generative AI model runs on the server or on a separate computing resource. In one embodiment, the generative AI model is implemented as a transformer-based neural network with multiple self-attention layers, positional encoding, and feed-forward layers. The model has been trained on large corpora of natural language text using unsupervised or self-supervised learning, and optionally fine-tuned on text rewriting and summarization tasks. During inference, the model receives as input the tokenized prompt and computes output token probabilities in an auto-regressive manner. The model applies an attention mechanism over the entire prompt context, including the prompt sentence and the original message, in order to generate context-appropriate output tokens that form a corrected sentence or a summary sentence.

The server receives the generated text from the generative AI model and performs validation. The server trims extraneous symbols, checks for empty or truncated outputs, and may apply a post-processing step to correct obvious errors. The server then re-applies the same or similar natural language processing pipeline to the generated text. Specifically, the server re-parses the generated text, recomputes sensitivity features and sensitivity degree, and recomputes emotional features and emotional degree. The server thereby obtains updated scores that reflect the sensitivity and emotional intensity of the generated text.

The server compares the updated scores with the predetermined thresholds. When the updated sensitivity degree or emotional degree remains above the thresholds, the server constructs an additional prompt sentence that explicitly instructs the generative AI model to further reduce sensitivity or emotional intensity. For instance, the server may generate a prompt sentence such as: “The following text is still too strong. Rewrite it again in more neutral and calm language while strictly avoiding insults or aggressive expressions: ‘[previous generated text]’.”

The server sends this additional prompt sentence to the generative AI model and receives another generated variant. The server may repeat this evaluation and regeneration process until the updated scores fall below the thresholds or a maximum number of iterations is reached. In this way, the server enforces machine-checkable constraints on the generative process and ensures that the final corrected sentence or summary sentence satisfies quantitative criteria for sensitivity and emotional intensity.

The server returns the corrected sentence or summary sentence to the sending-side terminal, along with the original text, the computed scores, and the display control flags. The terminal displays the original message and the suggested corrected or summarized message to the user. The terminal may present the suggestion in a dedicated panel with options for replacing the original text or dismissing the suggestion. For example, the terminal may show the message:

“This text may be offensive. Suggested polite wording: ‘I am having difficulty agreeing with your opinion. Could you explain it in more detail?’.”

The user may choose to adopt the suggested corrected sentence or summary sentence, to modify it, or to keep the original text. When the user confirms a version for sending, the terminal transmits the finalized text to the server as transmission information.

The server associates the transmission information with its identification information and display control flags and stores it in the database. The server forwards the transmission information to the receiving-side terminal. When the receiving-side terminal displays the transmission information, the terminal reads the identification information and display control flags. If the flags indicate that sensitive content should be hidden initially, the terminal renders the message as a collapsed item, with a warning such as: “This message contains sensitive content (emotion: anger). Do you want to open it?”

The receiving-side user can explicitly instruct the terminal to reveal or keep hiding the content by interacting with the user interface. The terminal responds in accordance with the instruction and the display control flags.

In some embodiments, the server additionally generates a low-impact summary of the transmission information for the receiving-side user. The server applies a summarization-oriented prompt sentence, such as:

“Summarize the following message in gentle and neutral language so that the main point is clear but the emotional impact is minimized: ‘[final message text]’.”

The server uses the generative AI model to produce a summary sentence and sends the summary sentence to the receiving-side terminal. The terminal may present the summary sentence first and allow the user to decide whether to display the full original content.

This architecture provides a technical improvement over conventional systems. The server uses structured quantitative scores and machine-readable flags to coordinate multiple processing modules: syntactic parsing, sensitivity/emotion evaluation, prompt construction, generative rewriting, iterative verification, and presentation control. The server thereby reduces redundant network round-trips caused by manual trial-and-error rewriting by users, because the rewriting occurs automatically under programmatic control and is checked against thresholds before being presented as a suggestion. The server also reduces the number of times high-sensitivity content is transmitted and rendered in full, by enabling initial non-display and summary-first display modes. As a result, the system improves network bandwidth utilization, reduces processing load on terminals that would otherwise render unnecessary content, and lowers the overall computational cost per successfully moderated and delivered message.

The server improves accuracy and consistency of sensitivity handling because the same evaluation function is applied both to the original input information and to the generated variants. The use of explicit thresholds and iterative regeneration allows the server to converge to a variant that satisfies predefined numerical goals, which is difficult to achieve by human editing or by a single-pass generative call without feedback. The architecture also improves processing speed and scalability, as the data structures and evaluation functions are designed to operate on compact feature representations, and the scoring and flagging logic can be executed in batch or in parallel across messages.

The server performs operations that are not conventional in human-only workflows and are not a mere automation of human judgment. The processor quantifies sensitivity and emotion in a high-dimensional feature space, generates and updates control signals that drive a neural generative model, and enforces formal constraints through iterative algorithmic feedback. The processor computes gradients and error signals when training the models, and uses regularization or data augmentation strategies during training to improve robustness. For example, during model training, the server may use an optimizer to update model parameters based on a loss function that combines language modeling loss with penalties for incorrectly predicting sensitivity or emotion labels. The server may augment training data with perturbed sentences that emphasize different stylistic or emotional properties, thereby enabling the model to more reliably separate semantic content from emotional tone.

The server distinguishes sensitivity and emotion management operations from generic data retrieval and display by defining specific message objects, score fields, and flag fields in its data structures. The server processes these fields according to predetermined algorithms that directly influence the behavior of terminals. The causal relationship between the processing and technical effects is clear: by evaluating sensitivity and emotion and using these values to generate control flags, the server changes when and how messages are rendered on terminals, thereby reducing the likelihood that high-sensitivity content is displayed without user consent. The system reduces processing overhead on terminals because the terminals can rely on the server's flags to avoid rendering full content until needed. These improvements manifest as measurable reductions in average rendering time, reduced network data volume for content that remains collapsed, and improved consistency in content handling across different devices and applications.

Alternative embodiments can modify or extend the described architecture. In one variation, the server executes the generative AI model locally using a hardware accelerator such as a graphics processing unit or tensor processing unit, rather than invoking an external service. In another variation, the server combines rule-based filters with neural scoring to refine sensitivity scoring. For example, the server may first use a rule-based engine that examines specific syntactic patterns, such as imperative sentences directed at a second person, and then apply the neural-based sensitivity degree to determine if those patterns are harmful. In yet another variation, the server supports multiple generative AI models with different architectures and selects among them depending on the message length, domain, or required latency.

Some embodiments use additional feature extractors, such as topic classifiers or discourse structure analyzers, to refine prompt sentences and to adjust how summaries are constructed. Some embodiments maintain user-specific or context-specific thresholds for sensitivity and emotion, allowing the server to adapt its behavior for different communication environments while still applying the same underlying technical processing operations.

Throughout these embodiments, the server, the terminals, and the users cooperate such that the server performs the computationally intensive analysis, transformation, and control logic; the terminals provide capture and presentation functions; and the users ultimately decide which suggested transformations to adopt and whether to reveal sensitive content. The described system thus provides a concrete, technically implemented mechanism to manage sensitive and emotional content in message communication with improved computational efficiency, accuracy, and control over display behavior, in accordance with the structure and functions recited in the claims.

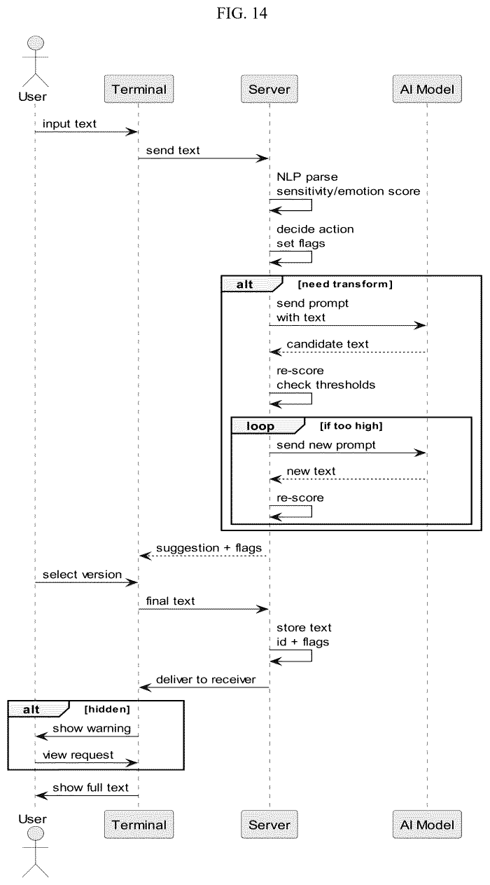

The following describes the processing flow using FIG. 14.

### Step 1:

User inputs message content on the terminal.

User types a text message into an input field or speaks into a microphone of the terminal.

Terminal receives raw keystroke events or audio signals as input. Terminal, when handling text input, concatenates the keystrokes into a character string and stores the string in a local buffer as output. Terminal, when handling voice input, applies a speech recognition engine to the audio signal as input, performs acoustic feature extraction and decoding, and generates a text transcription as output. Terminal displays the text transcription to the user and prepares it as input data for transmission.

### Step 2:

Terminal sends structured input information to the server.

Terminal takes the buffered text as input and encapsulates it into a structured message object that includes fields such as user identifier, timestamp, and device identifier. Terminal serializes this message object into a network payload and sends it to the server over a communication network. The output of the terminal in this step is the network payload containing the input information and associated metadata.

### Step 3:

Server receives input information and normalizes text.

Server receives the network payload from the terminal as input and extracts the text field and metadata fields. Server converts character encoding to a unified format, removes illegal characters, and normalizes whitespace and casing. Server constructs an internal message object containing the normalized text and metadata as output. Server logs the reception event together with the newly created message identifier.

### Step 4:

Server performs tokenization and syntactic parsing.

Server takes the normalized text from the message object as input and applies a natural language processing library to the text. Server executes a tokenizer to split the text into tokens, then runs a part-of-speech tagger and a dependency parser to compute grammatical relations. Server stores token strings, lemmas, part-of-speech tags, and dependency edges in an internal token list or parse tree structure as output. Server associates this structure with the message object for later processing.

### Step 5:

Server computes sensitivity features and a sensitivity degree.

Server uses the token list as input and compares each token lemma against a sensitivity lexicon stored as a hash map. Server increments category-specific counters (for example, insult count, threat count) when a token matches a lexicon entry and multiplies counts by predefined weights. Server aggregates these values into a single numerical sensitivity degree using an evaluation function, such as a weighted sum or normalized score. The output of this step is a sensitivity degree value and a set of category-specific feature counts attached to the message object.

### Step 6:

Server computes emotional features and an emotional degree.

Server takes the normalized text or the token embeddings as input and passes them into an emotion classification model implemented as a neural network. Server computes embedding vectors, propagates them through hidden layers with activation functions, and obtains output probabilities for emotion categories such as anger, sadness, and joy. Server selects the highest probability label as the dominant emotion and computes an emotional degree by mapping probabilities to a numerical scale. The output of this step is an emotion label and an emotional degree value stored in the message object.

### Step 7:

Server assigns identification information and display control flags.

Server uses the sensitivity degree and emotional degree as input and compares them to one or more predetermined thresholds. Server determines whether the message should be considered low, medium, or high in sensitivity and whether the emotional intensity exceeds a critical level. Based on these comparisons, server generates or retrieves unique identification information and sets one or more display control flags, such as a flag to indicate initial hiding or summary-only display. The output of this step is an updated message object that includes the identification information and display control flags.

### Step 8:

Server decides whether to use a generative AI model and selects a transformation type.

Server evaluates the sensitivity degree and emotional degree as input along with policy rules. Server decides, using conditional logic, whether the message requires transformation, such as rewriting into a softened expression or summarization. If thresholds are not exceeded, server sets an internal action code indicating no transformation. If thresholds are exceeded, server sets an action code for softened rewriting or for summary generation. The output of this step is an action code stored in the message object.

### Step 9:

Server constructs a prompt sentence for the generative AI model.

Server takes the original text, the dominant emotion, and the action code as input and generates a prompt sentence string. For a softening action, server may create a prompt sentence such as: “Please rewrite the following message in softer and polite language while preserving its essential meaning: ‘[original message]’.” For a summarization action, server may create a prompt sentence such as: “Summarize the following message in gentle and neutral wording so that the main point is clear but the emotional impact is reduced: ‘[original message]’.” Server combines the prompt sentence with model parameters to form a prompt. The output of this step is a formatted prompt ready to be sent to the generative AI model.

### Step 10:

Server sends the prompt to the generative AI model and generates a candidate sentence.

Server uses the constructed prompt as input and transmits the prompt to the generative AI model running on a local accelerator or remote inference service. Server tokenizes the prompt, feeds token sequences into the generative model, and obtains a sequence of output tokens as the model generates text. Server decodes the output tokens into a character string that constitutes a candidate corrected sentence or summary sentence. The output of this step is the candidate sentence associated with the original message.

### Step 11:

Server re-evaluates the candidate sentence for sensitivity and emotion.

Server takes the candidate sentence as input and performs the same natural language processing pipeline applied to the original text. Server tokenizes and parses the candidate sentence, recomputes sensitivity features, and derives a new sensitivity degree. Server also passes the candidate sentence through the emotion classification model to compute an updated emotional degree. The output of this step is a set of updated sensitivity and emotional scores attached to the candidate sentence.

### Step 12:

Server determines whether iterative regeneration is required.

Server compares the updated sensitivity degree and emotional degree from the candidate sentence as input to the predetermined thresholds. If either updated score exceeds the thresholds, server decides to perform another generation iteration. In that case, server builds an additional prompt sentence explicitly stating that the text remains too strong, such as: “The following text is still too strong. Rewrite it again in more neutral and calm language while strictly avoiding insults or aggressive expressions: ‘[previous generated text]’.” Server marks that another call to the generative AI model is required. If the updated scores fall below the thresholds, server marks the candidate sentence as acceptable. The output of this step is a decision flag indicating whether regeneration is needed and, if needed, an additional prompt sentence.

### Step 13:

Server repeats generation and evaluation until thresholds are satisfied or a limit is reached.

Server uses the additional prompt sentence and the previous generated text as input and repeats the operations of sending the prompt to the generative AI model and re-evaluating the resulting candidate. Server maintains a counter of iterations and stops regeneration when scores satisfy the thresholds or the counter reaches a maximum value. The output of this step is a final corrected sentence or summary sentence whose sensitivity and emotional scores are within acceptable ranges.

### Step 14:

Server prepares feedback and suggestions for the sending-side terminal.

Server takes the final corrected sentence or summary sentence, the original text, the sensitivity degree, the emotional degree, and any display control flags as input and builds a structured response object. Server includes fields indicating that a suggestion is available and, optionally, textual guidance such as “This message may hurt the receiver's feelings. Consider using the suggested version.” The output of this step is the structured response object transmitted over the network to the terminal.

### Step 15:

Terminal displays the suggestion and receives user selection.

Terminal receives the structured response object from the server as input and parses its fields. Terminal displays the original message and the suggested corrected sentence or summary sentence side by side, along with optional warnings based on the sensitivity degree and emotional degree. Terminal provides user interface controls that allow the user to adopt the suggested sentence, edit it, or ignore it. User interacts with the controls, and terminal records the selection as output. Terminal generates a finalized text according to the selection and prepares this finalized text as transmission information.

### Step 16:

Terminal sends finalized transmission information to the server.

Terminal takes the finalized text and associated metadata as input and constructs a new message payload for confirmed transmission. Terminal includes the identification information if already assigned, or requests new identification information from the server. Terminal sends the payload to the server over the network. The output of this step is the confirmed transmission information delivered to the server.

### Step 17:

Server stores transmission information and propagates display control flags.

Server receives the confirmed transmission information as input and associates it with identification information and display control flags. Server writes a record to persistent storage including the finalized text, the sensitivity and emotional scores, and the flags. Server prepares a delivery payload for the receiving-side terminal, embedding the identification information and the display control flags. The output of this step is the delivery payload ready for transmission to the receiving-side terminal.

### Step 18:

Server delivers the payload to the receiving-side terminal.

Server uses the delivery payload as input and sends it through a messaging or notification channel to the receiving-side terminal. The server may route the payload through intermediate services but preserves identification information and control flags. The output of this step is reception of the payload by the receiving-side terminal.

### Step 19:

Terminal on the receiving side renders the message according to the display control flags.

Terminal on the receiving side receives the delivery payload as input and extracts the finalized text, identification information, and display control flags. Terminal examines the flags to determine whether the content should be initially hidden, summarized, or fully displayed. When a flag indicates initial hiding, terminal renders a placeholder with a warning text and a control for revealing the content. When a flag indicates a summary-first mode and a summary has been provided, terminal displays the summary and hides the full text. The output of this step is a rendered user interface that reflects the control flags.

### Step 20:

User on the receiving side issues a viewing instruction, and the terminal updates the display.

User views the placeholder or summary and decides whether to see the full content. User interacts with a control, such as a button labeled “Open message,” which constitutes a viewing instruction. Terminal receives this viewing instruction as input and checks the display control flags and message state. Terminal then updates the display, replacing the placeholder or summary with the full finalized text of the transmission information. The output of this step is a new screen state in which the message content is visible or remains hidden according to the user's explicit choice.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

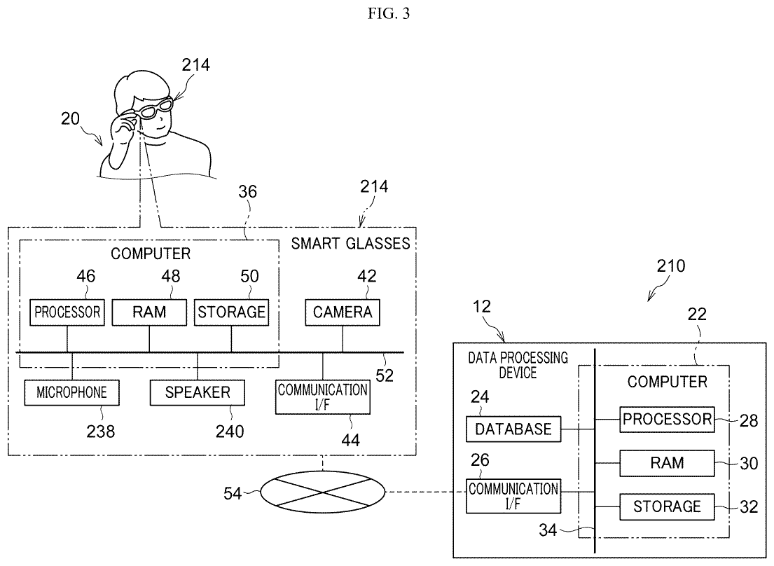

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

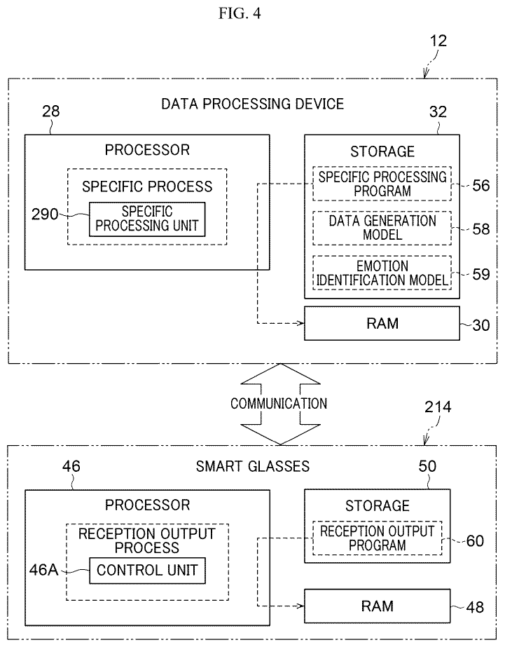

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### EXAMPLE 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### EXAMPLE 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

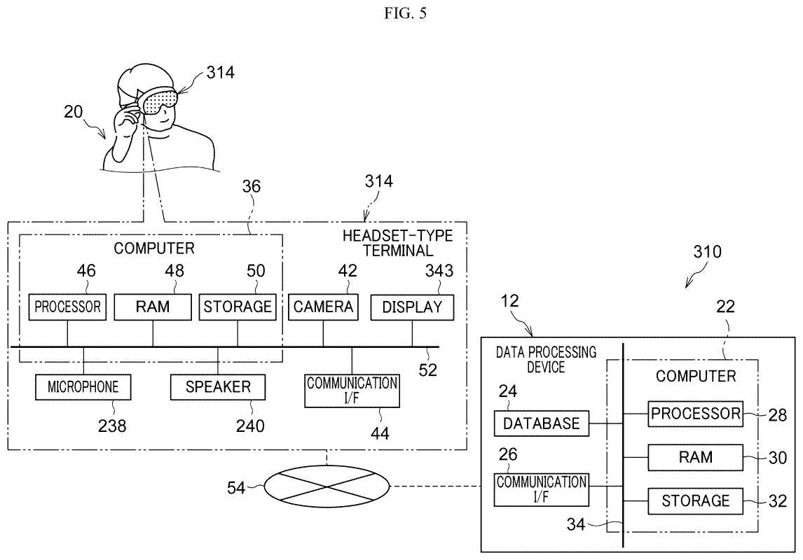

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

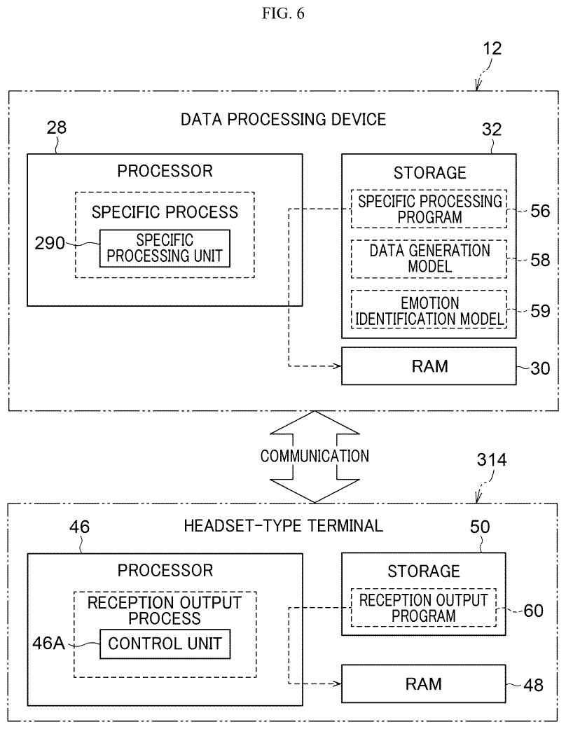

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### EXAMPLE 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### EXAMPLE 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

Fourth Exemplary Embodiment

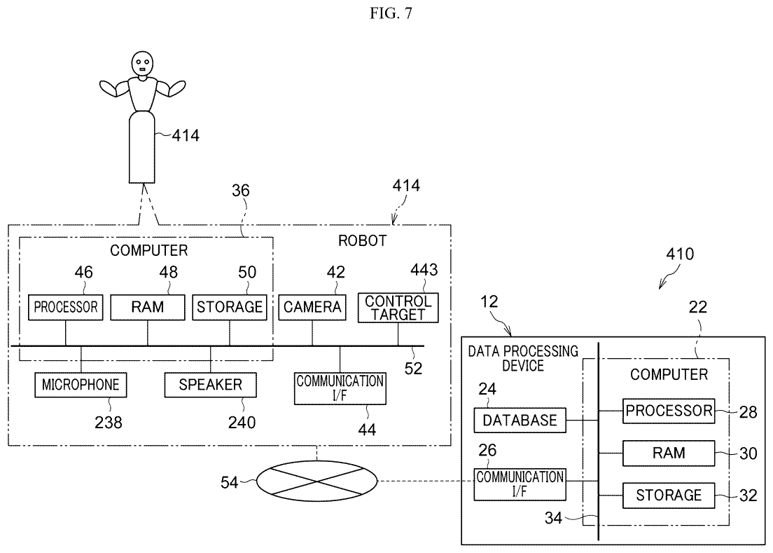

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

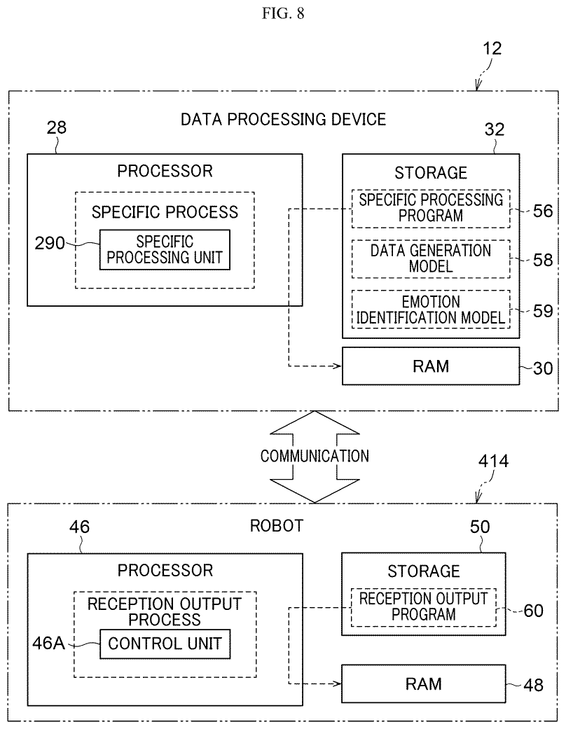

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### EXAMPLE 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### EXAMPLE 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

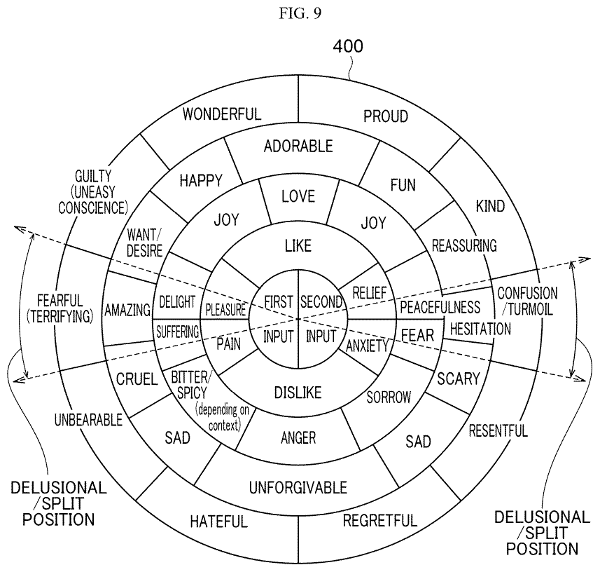

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

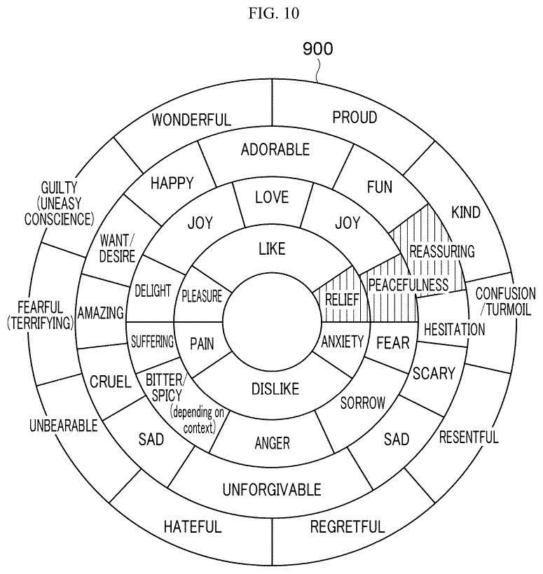

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### EXAMPLE 1

### (Supplementary 1)

A system comprising a processor,
wherein the processor is configured to
acquire character information transmitted from a user terminal and perform syntactic analysis and semantic analysis on the character information by using a natural language processing technique, thereby determining presence or absence of sensitive content included in the character information and calculating a sensitivity score by numerical evaluation of a degree of sensitivity according to a sensitivity evaluation criterion, and
when the sensitivity score exceeds a predetermined threshold, generate a prompt sentence for instructing a generative AI model to generate a correction proposal for the character information by generating an instruction sentence including content of the character information, the sensitivity score, and a sensitivity reason, and
input the prompt sentence to the generative AI model and acquire, from the generative AI model, a proposal sentence including an alternative expression that maintains an intention of the character information and is less likely to hurt a recipient, and
generate evaluation result notification information for transmission to the user terminal by including the sensitivity score and the proposal sentence and cause the user terminal to display the proposal sentence to a user, and
acquire, from the user terminal, corrected character information corrected by the user based on the proposal sentence and repeatedly execute the calculation of the sensitivity score and generation of the prompt sentence for the corrected character information so as to support stepwise correction until the character information satisfies a predetermined sensitivity condition.

### (Supplementary 2)

The system according to supplementary 1,
wherein the processor is configured to
assign identification information to the character information transmitted from the user terminal and to the proposal sentence, store the sensitivity score and display control information corresponding to a sensitivity level in association with the identification information, and apply, to a receiving terminal, a setting for hiding or partially displaying sensitive content by using the display control information and for displaying, in place of the sensitive content, at least one of a summary sentence in a soft expression or the proposal sentence generated by the generative AI model.

### (Supplementary 3)

The system according to supplementary 1,
wherein the processor is configured to
when the sensitivity score exceeds a predetermined threshold, generate a prompt sentence for instructing the generative AI model to generate a summary sentence that summarizes the character information in a soft expression unlikely to make a recipient feel uncomfortable, by generating an instruction sentence including main semantic content of the character information and the sensitivity reason, input the prompt sentence to the generative AI model, acquire the summary sentence from the generative AI model, and notify at least one of the user terminal or the receiving terminal of the summary sentence.

### Application Example 1

### (Supplementary 1)

A system comprising a processor,
wherein the processor is configured to
receive character information from a user terminal that acquires and transmits input information, via a communication unit,
perform preprocessing on the received character information by using a language processing technique, the preprocessing including dividing the character information into word sequences and converting the word sequences into numerical representations,
execute an inference process on the numerical representations by using a classification model, and calculate an evaluation value indicating presence or absence of sensitive content included in the character information and a degree of sensitivity,
determine, based on the evaluation value, whether the character information is sensitive, and, when the character information is determined to be sensitive, extract a sensitive portion from within the character information,
construct a prompt sentence, based on a determination result and the extracted sensitive portion, for causing a generative artificial intelligence model to generate an alternative expression or a softened expression, and input the prompt sentence to the generative artificial intelligence model,
generate response information including the alternative expression or a summary expression obtained from the generative artificial intelligence model as structured data, and transmit the structured data to the user terminal,
output, in a format enabling display control at the user terminal, evaluation information relating to the degree of sensitivity and at least one candidate of the alternative expression included in the structured data, so that a user can modify the character information prior to transmission, and
re-evaluate, by using the classification model, revised character information re-transmitted from the user terminal, and, when the degree of sensitivity is determined to be less than a predetermined threshold, confirm the revised character information as transmission target information.

### (Supplementary 2)

The system according to supplementary 1,
wherein the processor is configured to
assign identification information to each of pre-revision or post-revision character information, and transmit control information together with the identification information, the control information being used in a receiving apparatus to hide or emphasize a portion related to the sensitive content according to the identification information.

### (Supplementary 3)

The system according to supplementary 1,
wherein the processor is configured to
construct and input, to the generative artificial intelligence model, a prompt sentence for instructing generation of a summary expression that suppresses an amount of information while mitigating negative or aggressive wording, for character information whose evaluation value falls within a predetermined range.

### EXAMPLE 2

### (Supplementary 1)

A system comprising a processor,
wherein the processor is configured to
parse character information acquired from a user terminal by using a natural language processing technique, and determine presence or absence of sensitive content included in the character information and a sensitivity level of the sensitive content, and
calculate a sensitivity score for the character information based on the determination result and predefined evaluation criteria, and assign identification information indicating the sensitivity level to the character information, and
input, to a generative artificial intelligence model, a prompt sentence for causing the generative artificial intelligence model to generate a proposal sentence that mitigates sensitive expressions in the character information and a summary sentence that summarizes the character information in a softened expression, based on the sensitivity score and the sensitivity level, and
store the proposal sentence and the summary sentence output from the generative artificial intelligence model in association with the user terminal, control presentation of the proposal sentence to a transmitting user terminal, and control presentation of the summary sentence to a receiving user terminal, and
transmit the character information including the identification information to the receiving user terminal, and
output display control information for causing the receiving user terminal to initially hide at least a part of the character information based on the identification information and to allow the character information to be displayed only when a display instruction is received from a recipient.

### (Supplementary 2)

The system according to supplementary 1,
wherein the processor is configured to
output screen control information for causing the transmitting user terminal to visually emphasize a sensitive portion of the character information in accordance with the sensitivity score and the sensitivity level, and to present at least part of the proposal sentence as a selectable alternative candidate to the character information.

### (Supplementary 3)

The system according to supplementary 1,
wherein the processor is configured to
output control information for causing the receiving user terminal to display only the summary sentence while the character information is hidden based on the identification information, and to switch between display and non-display of the character information in response to a user operation from a display state of the summary sentence.

### Application Example 2

### (Supplementary 1)

A system comprising a processor,
wherein the processor is configured to
parse input information obtained from a user terminal using natural language processing to determine sensitive content and emotional features included in the input information,
score a sensitivity degree and an emotional degree of the input information by numerical evaluation in accordance with a predetermined evaluation criterion based on a determination result of the sensitive content and the emotional features,
assign identification information and a display control flag to the input information in order to control a display mode or a non-display mode when the input information is presented to a receiver in accordance with the scored sensitivity degree and emotional degree,
input a prompt including a prompt sentence to a generative AI model based on the scored sensitivity degree and the emotional features so as to cause the generative AI model to generate a candidate sentence for converting the input information into a softened expression or for summarizing a main point of the input information in a form with reduced emotional impact, and acquire a corrected sentence or a summary sentence from the generative AI model, and
present the acquired corrected sentence or summary sentence to the user terminal and, in response to a selection made by a user, replace the input information with the corrected sentence or the summary sentence and finalize the replaced sentence as transmission information.

### (Supplementary 2)

The system according to supplementary 1,
wherein the processor is configured to
control, based on the display control flag, a user terminal on a receiving side such that sensitive content in the transmission information is kept hidden in an initial state when a message is displayed using the identification information assigned to the transmission information, and the sensitive content is displayed only when a viewing instruction is received from a user on the receiving side.

### (Supplementary 3)

The system according to supplementary 1,
wherein the processor is configured to
re-evaluate the corrected sentence or the summary sentence acquired from the generative AI model by using the natural language processing to calculate the sensitivity degree and the emotional degree again, and input an additional prompt including an additional prompt sentence to the generative AI model to instruct regeneration when an evaluation result exceeds a predetermined threshold, thereby automatically obtaining transmission information that reduces emotional burden on the receiver.

What is claimed is:

1. A system comprising:
circuitry configured to:
receive, via a packet-switched network, character string data from a first terminal device;
segment the character string data into a sequence of token elements using a natural language processing technique and convert the token elements into numerical vector representations;
execute a forward inference pass on the numerical vector representations using a transformer-based neural network classifier comprising a plurality of self-attention layers and a classification output layer to compute a classification score value indicating a degree to which the character string data matches a predetermined classification criterion;
compare the classification score value with a stored threshold value and, when the classification score value exceeds the stored threshold value, construct an instruction sequence for a generative neural network model by concatenating at least a directive text portion, content derived from the character string data, and the classification score value into a structured prompt;
transmit the structured prompt via the packet-switched network to an information processing apparatus hosting the generative neural network model and receive, from the information processing apparatus, alternative output data generated by the generative neural network model in response to the structured prompt;
generate a structured notification record comprising the classification score value and the alternative output data and transmit the structured notification record to the first terminal device to cause the first terminal device to render the alternative output data on a display thereof;
receive, from the first terminal device, revised character string data and iteratively re-execute the forward inference pass and the construction of the instruction sequence for the revised character string data until the classification score value satisfies a predetermined condition; and
associate identification data with the character string data and generate presentation control data specifying a rendering state for a second terminal device, and transmit the presentation control data to the second terminal device via the packet-switched network to cause the second terminal device to suppress rendering of at least a portion of the character string data and to render the alternative output data in place thereof.

2. The system according to claim 1, wherein the circuitry is further configured to:
apply a tokenization operation to the character string data to produce subword token identifiers and generate corresponding attention mask arrays, and provide the subword token identifiers and the attention mask arrays as input to the transformer-based neural network classifier.

3. The system according to claim 2, wherein the transformer-based neural network classifier comprises:
an embedding layer that maps the subword token identifiers to dense vector representations,
a plurality of encoder layers each comprising a multi-head self-attention sublayer and a feed-forward sublayer with a non-linear activation function and layer normalization, and
the classification output layer comprising a fully connected layer and a softmax activation function that outputs a probability distribution over a plurality of classification categories.

4. The system according to claim 3, wherein:
the classification score value comprises a sensitivity score quantifying a degree of sensitivity of the character string data, and the predetermined classification criterion comprises a sensitivity evaluation criterion including at least thresholds and classification categories for different types of content determined to have potential to cause discomfort to a recipient.

5. The system according to claim 4, wherein:
the instruction sequence comprises an instruction sentence specifying a generation task, the content derived from the character string data, the sensitivity score, and a sensitivity reason derived from attention weight distributions of the transformer-based neural network classifier, and the alternative output data comprises a proposal sentence including an alternative expression that maintains an intention of the character string data while reducing a likelihood of causing discomfort.

6. The system according to claim 5, wherein the circuitry is further configured to:
construct a second instruction sequence for the generative neural network model, the second instruction sequence instructing the generative neural network model to generate a summary sentence that summarizes the character string data in a softened expression while preserving essential semantic content, and
transmit the summary sentence to at least one of the first terminal device or the second terminal device.

7. The system according to claim 6, wherein:
the presentation control data specifies that the second terminal device initially renders a placeholder element and the summary sentence in a display region, and reveals the character string data only in response to an explicit display instruction received from a recipient operating the second terminal device.

8. The system according to claim 7, wherein the circuitry is further configured to:
generate screen control data for the first terminal device, the screen control data specifying visual emphasis of portions of the character string data identified as contributing to the classification score value and presentation of the proposal sentence as a selectable alternative candidate.

9. The system according to claim 1, wherein the circuitry is further configured to:
re-execute the forward inference pass on the alternative output data generated by the generative neural network model to compute an updated classification score value, and
when the updated classification score value exceeds a stricter target threshold, modify the instruction sequence to impose additional constraints and retransmit the modified instruction sequence to the information processing apparatus to obtain regenerated alternative output data.

10. The system according to claim 9, wherein:
the circuitry repeats the re-execution and the modification until the updated classification score value falls below the stricter target threshold or a maximum iteration count is reached.

11. The system according to claim 1, wherein the circuitry is further configured to:
execute an emotion classification operation on the character string data using an emotion identification neural network comprising embedding layers, attention layers, and a classification output layer to produce emotion type information and a confidence value associated with the emotion type information.

12. The system according to claim 11, wherein:
the circuitry incorporates the emotion type information and the confidence value into the instruction sequence as conditioning parameters that influence a tone and style of the alternative output data generated by the generative neural network model.

13. The system according to claim 12, wherein:
the emotion identification neural network maps the character string data to an emotion value on an emotion map that arranges a plurality of emotion categories in a two-dimensional space, and the circuitry selects a generation strategy for the instruction sequence based on a position of the emotion value in the two-dimensional space.

14. The system according to claim 1, wherein the circuitry is further configured to:
perform character string normalization processing on the character string data including at least one of Unicode normalization, case conversion, or removal of control characters, and store both original and normalized versions of the character string data as indexed data records.

15. The system according to claim 14, wherein the circuitry is further configured to:
perform syntactic dependency parsing on the normalized character string data to produce a parse tree structure comprising token elements annotated with part-of-speech tags, lemma forms, and dependency relation labels, and utilize the parse tree structure as supplementary features for computing the classification score value.

16. The system according to claim 15, wherein the circuitry is further configured to:
maintain a classification lexicon data structure associating normalized word forms with category-specific weight values, compare token lemma forms against entries in the classification lexicon data structure, and compute a preliminary score by aggregating matched weight values modified by syntactic role information from the parse tree structure.

17. The system according to claim 1, wherein:
the generative neural network model comprises a transformer-based decoder network including a plurality of decoder layers each comprising a self-attention sublayer, a feed-forward sublayer with a non-linear activation function, and layer normalization, and the generative neural network model generates the alternative output data by iterative auto-regressive token prediction conditioned on the structured prompt with generation parameters including at least a sampling temperature value and a maximum output token length.

18. A system comprising:
circuitry configured to:
receive, via a packet-switched network, character string data from a first terminal device;
perform character string normalization processing on the character string data and segment the normalized character string data into a sequence of token elements using a natural language processing technique;
convert the token elements into numerical vector representations and execute a forward inference pass using a transformer-based neural network classifier comprising a plurality of self-attention layers and a classification output layer to compute a classification score value and determine a classification level;
execute an emotion classification operation on the character string data using an emotion identification neural network to produce emotion type information and a confidence value;
construct an instruction sequence for a generative neural network model by concatenating a directive text portion, content derived from the character string data, the classification score value, a classification reason derived from attention weight distributions, and the emotion type information;
transmit the instruction sequence to an information processing apparatus hosting the generative neural network model via the packet-switched network and receive alternative output data and condensed output data from the generative neural network model;
re-execute the forward inference pass on the alternative output data and the condensed output data to compute updated classification score values and, when at least one updated classification score value exceeds a predetermined threshold, retransmit a modified instruction sequence to the information processing apparatus to obtain regenerated output data;
generate a structured notification record comprising the classification score value, the alternative output data, and screen control data, and transmit the structured notification record to the first terminal device;
associate identification data with the character string data and generate presentation control data specifying an initial rendering state for a second terminal device; and
transmit the presentation control data and the condensed output data to the second terminal device via the packet-switched network to cause the second terminal device to suppress rendering of the character string data and render the condensed output data, and to reveal the character string data only in response to an explicit display instruction from a recipient.

19. The system according to claim 18, wherein the circuitry is further configured to:
maintain adaptive threshold parameters that are adjusted based on accumulated interaction log data indicating a frequency at which alternative output data is adopted and a frequency at which suppressed content is revealed at second terminal devices.

20. A method comprising:
receiving, via a packet-switched network, character string data from a first terminal device;
segmenting the character string data into a sequence of token elements using a natural language processing technique and converting the token elements into numerical vector representations;
executing a forward inference pass on the numerical vector representations using a transformer-based neural network classifier comprising a plurality of self-attention layers and a classification output layer to compute a classification score value indicating a degree to which the character string data matches a predetermined classification criterion;
comparing the classification score value with a stored threshold value and, when the classification score value exceeds the stored threshold value, constructing an instruction sequence for a generative neural network model by concatenating at least a directive text portion, content derived from the character string data, and the classification score value into a structured prompt;
transmitting the structured prompt via the packet-switched network to an information processing apparatus hosting the generative neural network model and receiving, from the information processing apparatus, alternative output data generated by the generative neural network model in response to the structured prompt;
generating a structured notification record comprising the classification score value and the alternative output data and transmitting the structured notification record to the first terminal device to cause the first terminal device to render the alternative output data on a display thereof;
receiving, from the first terminal device, revised character string data and iteratively re-executing the forward inference pass and the construction of the instruction sequence for the revised character string data until the classification score value satisfies a predetermined condition; and
associating identification data with the character string data and generating presentation control data specifying a rendering state for a second terminal device, and transmitting the presentation control data to the second terminal device via the packet-switched network to cause the second terminal device to suppress rendering of at least a portion of the character string data and to render the alternative output data in place thereof.
